(19) United States
(12) Patent Application Publication
(10) Pub. No.: US 2026/0332303 A1
(43) Pub. Date: Oct. 22, 2026

(54) CHANNEL INTERLEAVING FOR PHYSICAL BROADCAST CHANNEL (PBCH)

(71) Applicant: Lenovo (United States) Inc., Morrisville, NC (US)

(72) Inventors: Abir Ben Hadj Fredj, Wiesbaden (DE); Karthikeyan Ganesan, Nauheim (DE); Razvan-Andrei Stoica, Essen (DE); Ali Ramadan Ali, Kraiburg (DE)

(73) Assignee: Lenovo (United States) Inc., Morrisville, NC (US)

(21) Appl. No.: 19/418,806

(22) Filed: Dec. 12, 2025

(51) Int. Cl. H04L 1/00

(52) U.S. Cl. CPC H04L 1/0071; H04L 1/0068

(57) ABSTRACT

Various aspects of the present disclosure relate to channel interleaving for physical broadcast channel (PBCH). A network entity (NE) encodes, using a polar encoder, a PBCH payload according to a polar sequence to generate a polar codeword, where the PBCH payload is associated with a synchronization signal block (SSB). The NE applies a channel interleaving pattern to the polar codeword based on a carrier channel bandwidth determination. The NE adjusts the SSB to fit within the carrier channel bandwidth and transmits the SSB including the PBCH payload over a synchronization raster. A user equipment (UE) receives the SSB over the synchronization raster, determines to enable channel de-interleaving based on the carrier channel bandwidth, and applies the channel de-interleaving to received bits of the SSB to generate de-interleaved bits. The UE decodes, using a polar decoder, the PBCH payload from the SSB based on the de-interleaved bits.

### TECHNICAL FIELD

The present disclosure relates to wireless communications, and more specifically to encoding physical broadcast channel (PBCH) transmissions.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

An NE (e.g., a base station) for wireless communication is described. The NE may be configured to, capable of, or operable to perform one or more operations as described herein. For example, the NE may be configured to, capable of, or operable to encode, using a polar encoder, a PBCH payload according to a polar sequence to generate a polar codeword, where the PBCH payload is associated with a synchronization signal block (SSB), apply a channel interleaving pattern to the polar codeword as a result of a determination to enable channel interleaving based on a carrier channel bandwidth, adjust the SSB to fit within the carrier channel bandwidth, and transmit the SSB including the PBCH payload over a synchronization raster within the carrier channel bandwidth.

A processor (e.g., a standalone processor chipset, or a component of an NE) for wireless communication is described. The processor may be configured to, capable of, or operable to perform one or more operations as described herein. For example, the processor may be configured to, capable of, or operable to encode, using a polar encoder, a PBCH payload according to a polar sequence to generate a polar codeword, where the PBCH payload is associated with an SSB, apply a channel interleaving pattern to the polar codeword as a result of a determination to enable channel interleaving based on a carrier channel bandwidth, adjust the SSB to fit within the carrier channel bandwidth, and transmit the SSB including the PBCH payload over a synchronization raster within the carrier channel bandwidth.

A method performed or performable by an NE (e.g., a base station) for wireless communication is described. The method may include encoding, using a polar encoder, a PBCH payload according to a polar sequence to generate a polar codeword, where the PBCH payload is associated with an SSB, applying a channel interleaving pattern to the polar codeword subsequent to rate matching as a result of a determination to enable channel interleaving based on a carrier channel bandwidth, adjusting the SSB to fit within the carrier channel bandwidth, and transmitting the SSB including the PBCH payload over a synchronization raster within the carrier channel bandwidth.

In some implementations of the NE, the processor, and the method described herein, the channel interleaving pattern includes a pre-defined permutation configured to map polar bits corresponding to reliable bit-channels to REs that are preserved when adjusting the SSB to fit within the carrier channel bandwidth. In some implementations of the NE, the processor, and the method described herein, adjusting the SSB to fit within the carrier channel bandwidth includes puncturing one or more resource blocks from an upper frequency edge or a lower frequency edge of the SSB based on a bandwidth of the SSB being greater than the carrier channel bandwidth. In some implementations of the NE, the processor, and the method described herein, the channel interleaving pattern is selected from a set of channel interleaving patterns based on a quantity of resource blocks available for transmission of the SSB or the carrier channel bandwidth.

In some implementations of the NE, the processor, and the method described herein, the channel interleaving pattern is configured based on the polar sequence, and bits corresponding to frozen bit positions in the polar sequence are mapped to REs in an upper frequency edge or a lower frequency edge of the SSB, and bits corresponding to information bit positions and parity bit positions in the polar sequence are mapped to REs at a center frequency region of the SSB. In some implementations of the NE, the processor, and the method described herein, the channel interleaving is enabled if the carrier channel bandwidth is less than five megahertz (MHz), and the channel interleaving is disabled if the carrier channel bandwidth is equal to or greater than five MHz. In some implementations of the NE, the processor, and the method described herein, the channel interleaving is enabled if the carrier channel bandwidth is less than a bandwidth of the SSB, and the channel interleaving is disabled if the carrier channel bandwidth is equal to or greater than the bandwidth of the SSB.

In some implementations of the NE, the processor, and the method described herein, the synchronization raster is a single synchronization raster used for a first bandwidth and a second bandwidth greater than the first bandwidth, and the single synchronization raster has a raster spacing that is a common divisor of the first bandwidth and the second bandwidth. In some implementations of the NE, the processor, and the method described herein, a first set of physical cell identifiers (PCIs) corresponds to the first bandwidth and a second set of PCIs corresponds to the second bandwidth, and a primary synchronization signal (PSS) and a secondary synchronization signal (SSS) included in the SSB are generated using a PCI corresponding to the carrier channel bandwidth, where the PCI indicates the carrier channel bandwidth.

In some implementations of the NE, the processor, and the method described herein, a first synchronization raster is associated with a first bandwidth, a second synchronization raster is associated with a second bandwidth greater than the first bandwidth, and the synchronization raster over which the SSB is transmitted is the first synchronization raster if the carrier channel bandwidth corresponds to the first bandwidth and is the second synchronization raster if the carrier channel bandwidth corresponds to the second bandwidth. In some implementations of the NE, the processor, and the method described herein, adjusting the SSB includes, if the carrier channel bandwidth corresponds to the first bandwidth, puncturing the polar codeword to obtain a rate-matched sequence having a first sequence length, and if the carrier channel bandwidth corresponds to the second bandwidth, repeating bits of the polar codeword to obtain the rate-matched sequence having a second sequence length, where the second sequence length is greater than the first sequence length.

A UE for wireless communication is described. The UE may be configured to, capable of, or operable to perform one or more operations as described herein. For example, the UE may be configured to, capable of, or operable to receive an SSB over a synchronization raster, apply channel de-interleaving to received bits of the SSB to generate de-interleaved bits as a result of a determination to enable the channel de-interleaving based on a carrier channel bandwidth, and decode, using a polar decoder, a PBCH payload based on the de-interleaved bits.

A processor (e.g., a standalone processor chipset, or a component of a UE) for wireless communication is described. The processor may be configured to, capable of, or operable to perform one or more operations as described herein. For example, the processor may be configured to, capable of, or operable to receive an SSB over a synchronization raster, apply channel de-interleaving to received bits of the SSB to generate de-interleaved bits as a result of a determination to enable the channel de-interleaving based on a carrier channel bandwidth, and decode, using a polar decoder, a PBCH payload based on the de-interleaved bits.

A method performed or performable by a UE for wireless communication is described. The method may include receiving an SSB over a synchronization raster, applying channel de-interleaving to received bits of the SSB to generate de-interleaved bits as a result of a determination to enable the channel de-interleaving based on a carrier channel bandwidth, and decoding, using a polar decoder, a PBCH payload based on the de-interleaved bits.

In some implementations of the UE, the processor, and the method described herein, the channel de-interleaving corresponds to an inverse of a channel interleaving pattern applied at a transmitter of the SSB. In some implementations of the UE, the processor, and the method described herein, determining whether to enable the channel de-interleaving includes detecting the carrier channel bandwidth based on receiving the SSB, enabling the channel de-interleaving if the carrier channel bandwidth is less than five MHz, and disabling the channel de-interleaving if the carrier channel bandwidth is equal to or greater than five MHz.

In some implementations of the UE, the processor, and the method described herein, determining whether to enable the channel de-interleaving includes detecting the carrier channel bandwidth based on receiving the SSB, enabling the channel de-interleaving if the carrier channel bandwidth is less than a bandwidth of the SSB, and disabling the channel de-interleaving if the carrier channel bandwidth is equal to or greater than the bandwidth of the SSB. In some implementations of the UE, the processor, and the method described herein, the synchronization raster is a single synchronization raster used for a first bandwidth and a second bandwidth greater than the first bandwidth, and the single synchronization raster has a raster spacing that is a common divisor of the first bandwidth and the second bandwidth.

In some implementations of the UE, the processor, and the method described herein, determining whether to enable the channel de-interleaving includes detecting a PCI from a PSS or an SSS in the SSB, enabling the channel de-interleaving if the PCI belongs to a first set of PCIs corresponding to the first bandwidth, and disabling the channel de-interleaving if the PCI belongs to a second set of PCIs corresponding to the second bandwidth. In some implementations of the UE, the processor, and the method described herein, determining whether to enable the channel de-interleaving includes enabling the channel de-interleaving if the synchronization raster is a first synchronization raster associated with a first bandwidth, and disabling the channel de-interleaving if the synchronization raster is a second synchronization raster associated with a second bandwidth greater than the first bandwidth.

### BRIEF DESCRIPTION OF THE DRAWINGS

FIG. 1 illustrates an example of a wireless communications system in accordance with aspects of the present disclosure.

FIG. 2 illustrates an example SSB, in accordance with aspects of the present disclosure.

FIG. 3 illustrates an example of configuration options, in accordance with aspects of the present disclosure.

FIG. 4 illustrates an example synchronization raster and SSB configuration, in accordance with aspects of the present disclosure.

FIG. 5 illustrates an example channel combining diagram, in accordance with aspects of the present disclosure.

FIG. 6 illustrates an example channel polarization, in accordance with aspects of the present disclosure.

FIGS. 7 and 8 illustrates example encoding chains, in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of an NE in accordance with aspects of the present

### DISCLOSURE

FIG. 12 illustrates a flowchart of a method performed by a UE in accordance with aspects of the present disclosure.

FIG. 13 illustrates a flowchart of a method performed by an NE in accordance with aspects of the present disclosure.

### DETAILED DESCRIPTION

A wireless communications system includes one or more devices (e.g., UEs and NEs) that exchange signaling. “Initial access” refers to a process by which a device, such as a UE, establishes and configures an initial connection with a network or cell, e.g., via an NE. For example, an NE broadcasts, to UEs in a cell served by the NE, system information that enables the UE(s) to perform cell selection and reselection procedures and, if appropriate, initiate a connection establishment procedure to connect to the NE. Transmission channels for initial access include PSSs, SSSs, and PBCHs. In some examples, the NE may broadcast an initial access transmission referred to as a synchronization signal block (SSB), where the SSB includes PSS, SSS, and PBCH. The PBCH carries a master information block (MIB) that indicates system parameters for the cell, such as cell bandwidth, subcarrier spacing (SCS), and configuration of a control resource set (CORESET) #0. The NE broadcasts the initial access transmission according to a transmission periodicity.

When a UE enters the cell, the UE monitors one or more transmission channels to receive the information broadcast by the NE. The UE, for instance, synchronizes with the NE by receiving the PSS and/or SSS, and decodes the PBCH to obtain the MIB indicating configuration parameters for the cell. The UE monitors the CORESET #0 to determine scheduling information (e.g., time-frequency resource(s)) for receiving a system information block (SIB) 1. The SIB1 includes additional network access information of categories such as cell selection information, cell access related information, connection establishment failure control, system information (SI) scheduling information, serving cell common configuration, internet protocol (IP) multimedia subsystem (IMS) emergency support flag, eCall over IMS support flag, UE timers and constants, UAC barring information, use full resume identity (ID) flag, and the like, among other examples. The SIB1 is transmitted by the NE according to a transmission periodicity. Using the SSB and the SIB1, the UE can then initiate a connection establishment procedure and transition from the idle mode to a connected mode (e.g., RRC connected mode) to communicate with the NE.

The SSB is transmitted within a synchronization raster, which indicates frequency positions where the UE scans for the SSB during initial access. The SSB includes a PBCH payload of 32 bits corresponding to the MIB. The NE encodes the SSB using a polar encoder to generate a polar codeword of 512 bits. For legacy 5G NR devices, the PBCH is mapped to 20 resource blocks (RBs) in the frequency domain and four OFDM symbols in the time domain. However, subsequent 3GPP releases, including Release 18, introduced support for devices with different capabilities, such as reduced capability (RedCap) devices, enhanced reduced capability (eRedCap) devices, and devices for mission critical networks (MCN). To accommodate these devices, the minimum channel bandwidth was reduced from 5 MHz to 3 MHz, and an additional synchronization raster was created to support the 3 MHz channel bandwidth. Devices that support a minimum spectrum allocation of 5 MHz or greater scan for the SSB on the synchronization raster configured for the 5 MHz channel bandwidth, while devices that support a minimum spectrum allocation of 3 MHz scan for the SSB on the synchronization raster configured for the 3 MHz channel bandwidth.

Because the 3 MHz channel bandwidth cannot accommodate the 20 RB SSB structure, during encoding at the NE, the SSB is punctured by removing 4 RBs from an upper frequency edge and 4 RBs from a lower frequency edge of the SSB, resulting in a 12 RB punctured SSB that fits within the 3 MHz channel bandwidth. This RB-level puncturing negatively impacts the performance and coverage of the PBCH because the puncturing removes REs (REs) corresponding to the upper and lower frequency edges of the SSB without consideration of which bit positions carry information bits, parity bits, or frozen bits according to the polar code structure. Thus, the puncturing may remove bit positions corresponding to reliable bit-channels that carry information bits or parity bits, which are used for successful polar decoding at the UE. The polar decoder of the UE relies on the reliabilities of the bit-channels to perform successive cancellation decoding, and puncturing reliable bit-channels results in degraded decoding performance and reduced PBCH coverage.

Accordingly, the techniques described herein provide encoding techniques that support SSB transmission within reduced channel bandwidths without negatively impacting performance. For example, an NE may implement channel interleaving for PBCH transmissions. A channel interleaver may be added to the encoding chain at the NE, positioned after rate matching and before modulation. The channel interleaver is activated or deactivated based on a carrier channel bandwidth used for transmission of the SSB. When the carrier channel bandwidth is equal to or greater than the bandwidth of the SSB, the channel interleaver is deactivated (e.g., as puncturing is not needed to fit the SSB within the carrier channel bandwidth). When the carrier channel bandwidth is less than the bandwidth of the SSB, the channel interleaver is activated to fit the SSB within the carrier channel bandwidth. The channel interleaver reorders the bits of a polar codeword output by the rate matching to position information bits and parity bits at REs corresponding to a center frequency region of the SSB, and to position frozen bits at REs corresponding to upper and lower frequency edges of the SSB. Thus, when the NE performs RB-level puncturing to fit the SSB within the carrier channel bandwidth, the puncturing removes REs at the upper and lower frequency edges, which—as a result of the channel interleaver—correspond to frozen bits rather than information bits or parity bits.

Additionally, or alternatively, the NE may select between multiple rate matching patterns for PBCH transmissions based on the carrier channel bandwidth. When the carrier channel bandwidth is equal to or greater than the bandwidth of the SSB, the NE selects a first rate matching pattern corresponding to repetition. When the carrier channel bandwidth is less than the bandwidth of the SSB, the NE selects a second rate matching pattern corresponding to bit-level puncturing. The second rate matching pattern is configured to puncture bit positions corresponding to frozen bits and preserve bit positions corresponding to information bits or parity bits. By performing puncturing at the bit level rather than at the RB level, the rate matching accounts for the polar sequence and reliabilities of bit-channels, which may maintain polar decoding performance at the UE.

The described techniques provide improvements in PBCH decoding performance when the SSB is adjusted to fit within a carrier channel bandwidth. By applying a channel interleaving pattern that maps polar bits corresponding to frozen bit positions to REs at the upper and lower frequency edges of the SSB, the techniques described herein may ensure that puncturing the frequency edges of the SSB removes bits corresponding to unreliable bit-channels rather than bits corresponding to reliable bit-channels. Similarly, by selecting a rate matching pattern that punctures bit positions corresponding to frozen bits and preserves bit positions corresponding to information bits or parity bits, the techniques described herein may maintain the integrity of the polar code structure. These approaches may preserve decoder performance at the UE and reduce coverage loss when the SSB is adjusted to fit within a narrower carrier channel bandwidth. Additionally, by enabling or disabling channel interleaving based on the carrier channel bandwidth, or by selecting different rate matching patterns based on the carrier channel bandwidth, the techniques described herein may maintain compatibility with devices operating on wider channel bandwidths while providing improved performance for devices operating on narrower channel bandwidths.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

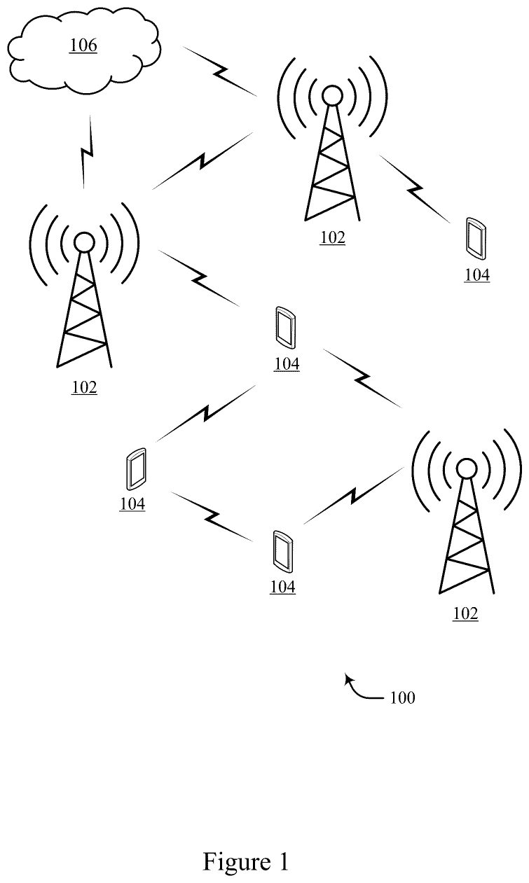

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Channel coding represents a fundamental component of wireless communications systems. Forward error correction (FEC) codes enable reliable transmissions over noisy wireless channels by adding redundancy to transmitted information bits, which assists a decoder in recovering transmitted information. A channel capacity defines a theoretical upper limit on the rate of information transmission and determines a highest rate at which reliable communication is achievable.

In 5G standards, low density parity check (LDPC) codes and cyclic redundancy check (CRC)-aided polar codes are adopted for data channels and control channels, respectively. Polar codes provide improved performance for broadcast channels, including the PBCH. The PBCH carries a fixed payload size of 32 bits corresponding to the MIB, which is encoded at a transmitting device (e.g., an NE 102) using a polar code encoder to generate a polar codeword of 512 bits. The PBCH is included in the SSB and is mapped to REs corresponding to the second and fourth symbols and parts of the third symbol of the SSB time-frequency resource grid, preceded by the PSS and followed by the SSS. For legacy 5G NR devices, the minimum carrier bandwidth is 5 MHz, where 20 RBs, corresponding to 240 subcarriers, in the frequency domain are allocated to the SSB with 4 symbols in the time domain.

Subsequent 3GPP releases introduced support for devices with different capabilities, including RedCap devices, eRedCap devices, and devices for MCN. To accommodate these devices, the minimum spectrum allocation was reduced to 3 MHz. A synchronization raster represents frequency locations where a device is expected to receive an SSB during initial cell search. The existing NR synchronization raster was designed for a minimum channel bandwidth of 5 MHz. For the 3 MHz channel bandwidth, a dedicated synchronization raster was introduced with approximately twice the granularity, providing deployment flexibility in narrow spectrum deployments. Changes were also made to downlink control resources used during initial access, including CORESET0, to fit within available transmission bandwidths.

Conventionally, to fit the 20 RB SSB within a reduced channel bandwidth of less than 5 MHz (e.g., 3 MHz), a transmitting device (e.g., an NE 102) performs RB-level puncturing of the SSB and remove RBs from its outer frequency edges. Puncturing at the RB level can negatively impact decoding performance when the puncturing fails to consider the polar code structure, e.g., as information bits needed for proper decoding at a receiver may be removed. The techniques described herein address this issue through channel interleaving and rate matching adaptation for PBCH transmissions.

In some implementations, the wireless communications system 100 supports channel interleaving for PBCH transmissions. A channel interleaver may be added to the encoding chain at the NE 102, positioned after rate matching and before modulation. The NE 102 activates or deactivates the channel interleaver when encoding a PBCH payload based on a carrier channel bandwidth in which the SSB is to be transmitted. When the carrier channel bandwidth is 5 MHz or greater, the channel interleaver is deactivated because the SSB fits within the carrier channel bandwidth without puncturing. When the carrier channel bandwidth is less than 5 MHz, such as 3 MHz, the channel interleaver is activated to prepare the polar codeword for RB-level puncturing. Additionally, or alternatively, the NE 102 may enable channel interleaving when the carrier channel bandwidth is less than the bandwidth of the SSB and disable channel interleaving when the carrier channel bandwidth is equal to or greater than the bandwidth of the SSB.

The channel interleaver reorders the bits of the polar codeword based on the polar sequence, which defines which bit positions correspond to reliable bit-channels and which bit positions correspond to unreliable bit-channels. Information bits and parity bits are assigned to reliable bit-channels, and frozen bits are assigned to unreliable bit-channels. The channel interleaver applies a permutation pattern (also referred to herein as an interleaving pattern) to the polar codeword bits, where the permutation pattern is configured to map bits corresponding to reliable bit-channels to REs at a center frequency region of the SSB, and to map bits corresponding to unreliable bit-channels to REs at upper and lower frequency edges of the SSB. Thus, when RB-level puncturing is subsequently performed to fit the SSB within the carrier channel bandwidth, the puncturing removes REs at the upper and lower frequency edges, which correspond to frozen bits rather than information bits or parity bits. The NE 102 transmits the SSB including the PBCH payload over a synchronization raster.

The permutation performed by the channel interleaver ensures that RB-level puncturing impacts unreliable bit-channels corresponding to frozen bits, which improves block error rate (BLER) performance. The channel interleaver also provides protection against burst errors by distributing bit locations according to the permutation pattern. In some examples, the permutation pattern is preconfigured.

A receiving device (e.g., a UE 104) may include a channel de-interleaver in a decoding chain used to decode and process received transmissions. The UE 104 may activate or deactivate the channel de-interleaver according to the same conditions as the transmitting device. For example, the UE 104 may detect or receive an indication of the channel bandwidth and may activate or deactivate the channel de-interleaver when decoding the received SSB (e.g., including the PBCH payload) based on the carrier channel bandwidth. The channel de-interleaver may de-interleave received bits of the SSB according to the inverse of the permutation pattern applied by the transmitting device.

In some examples, an interleaving flag indicates whether channel interleaving is enabled or disabled. A first value of the interleaving flag may correspond to a carrier channel bandwidth of 5 MHz or greater and may indicate that the channel interleaver is deactivated. A second value of the interleaving flag may correspond to a carrier channel bandwidth of 3 MHz, indicating that the channel interleaver is activated. The NE 102 may set the value of the interleaving flag and indicate the interleaving flag to the UE 104.

In some implementations, the wireless communications system 100 supports rate matching pattern selection for PBCH transmissions. When encoding the PBCH payload of the SSB, the NE 102 selects a rate matching pattern from one or more rate matching patterns based on the carrier channel bandwidth. The rate matching pattern is selected to avoid RB-level puncturing that does not account for the polar code construction. For example, the rate matching pattern may be bit-level rate matching that include repetition, shortening, or puncturing of the polar codeword. The rate matching pattern may comprise a puncturing pattern configured, based on bit-channel reliabilities of the polar sequence, to puncture bit positions corresponding to frozen bits of the polar sequence and preserve bit positions corresponding to information bits or parity bits.

For example, a first rate matching pattern may be configured for a 5 MHz channel bandwidth and a second rate matching pattern may be configured for a 3 MHz bandwidth, and the NE 102 selects an appropriate rate matching pattern based on the carrier channel bandwidth. In some examples, the NE 102 may determine an output sequence length and an effective code rate for the bit-level rate matching based on the carrier channel bandwidth, and may select the rate matching pattern based on the output sequence length and the effective code rate. The UE 104 may likewise select the rate matching pattern based on detecting or otherwise determining the carrier channel bandwidth associated with the received SSB. The first rate matching pattern may perform repetition of the polar bits, while the second rate matching pattern is configured to puncture bit positions corresponding to frozen bits and preserve bit positions corresponding to information bits or parity bits. This ensures that reliable bit-channels carrying information bits or parity bits remain available for polar decoding in reduced channel bandwidths, while frozen bits transmitted over unreliable bit-channels are punctured. Bit-level rate matching provides improved performance compared to RB-level puncturing.

The wireless communications system 100 may support dual synchronization raster configurations or single synchronization raster configurations for channel interleaving activation and rate matching pattern selection. In a dual synchronization raster configuration, a first synchronization raster is associated with a first carrier channel bandwidth (e.g., a reduced channel bandwidth, such as 3 MHz) and a second synchronization raster is associated with a second carrier channel bandwidth (e.g., 5 MHz) greater than the first carrier channel bandwidth. The UE 104 determines whether to activate channel interleaving or which rate matching pattern to select based on which synchronization raster the UE 104 is configured to scan. In a single synchronization raster configuration, the synchronization raster is designed assuming a minimum spectrum allocation of 3 MHz, and is thus used for both 3 MHz and 5 MHz channel bandwidths. The single synchronization raster may be configured with a raster spacing that is a common divisor of the first carrier channel bandwidth and the second carrier channel bandwidth.

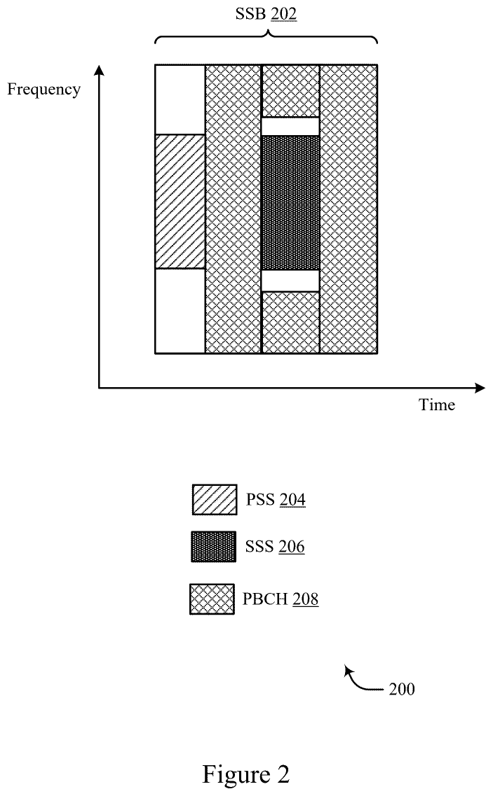

FIG. 2 illustrates an example SSB format 200 in accordance with aspects of the present disclosure. In some examples, the SSB format 200 implements or is implemented by aspects of the wireless communications system 100. The SSB format 200 may be implemented by a UE or an NE, which may be examples of a UE 104 and an NE 102 as described with reference to FIG. 1. For example, an NE may broadcast an SSB 202 according to the SSB format 200 to UEs in a cell served by the NE.

Cell search is the procedure for a UE to acquire time and frequency synchronization with a cell and to detect a PCI of the cell. During cell search operations, which are carried out when a UE is powered on, during mobility in connected mode, during idle mode mobility (e.g., reselections), during inter-RAT mobility to NR system, or in other scenarios, the UE uses NR synchronization signals and PBCH to derive the information required to access the cell. Two types of synchronization signals are defined for NR: a PSS 204 and an SSS 206. The SSB 202 consists of the PSS 204, the SSS 206, and a PBCH 208.

In 5G NR systems, an SSB burst structure spans a 5 ms duration, corresponding to half of a radio frame. SSB transmission may occur in either the first half or second half of a 10 ms radio frame, with this timing information indicated in a corresponding MIB. An SSB 202 is periodically transmitted with a periodicity of 5 ms, 10 ms, 20 ms, 40 ms, 80 ms, or 160 ms. While longer SSB periodicities may enhance network energy performance, shorter periodicities may facilitate faster cell search for UEs. A UE may assume a default periodicity of 20 ms during initial cell search or idle mode mobility, while the actual operational periodicity of SSBs may be subsequently indicated within SIB1 after successful initial access.

The maximum number of candidate SSB transmissions within a wireless communications system is determined by an operating frequency range and configured subcarrier spacing parameters. For FR1, which encompasses frequencies below 6 GHz, the maximum number of candidate SSBs is limited to 8. In contrast, FR2, covering frequencies above 24 GHz, supports up to 64 candidate SSB transmissions to accommodate the higher frequency propagation characteristics and beam management requirements.

PSS 204, SSS 206, and PBCH 208 are transmitted as a unified structure within consecutive OFDM symbols, forming a complete SSB (e.g., the SSB 202). The PSS 204 provides coarse timing and frequency synchronization, the SSS 206 enables cell identity determination and fine synchronization, and the PBCH 208 carries the MIB containing system parameters such as system frame number, subcarrier spacing configuration, and CORESET0 scheduling information. Each SSB occupies a time-frequency resource allocation of 4 consecutive OFDM symbols in the time domain and spans 240 subcarriers, equivalent to 20 RBs, in the frequency domain. The 4-symbol structure provides a compact transmission format that may be repeated within SSB burst sets according to configured periodicities, where each RB comprises 12 subcarriers with 15 kHz subcarrier spacing in FRI implementations.

Time-frequency resource allocations may be positioned at different locations within a slot depending on the SSB case configuration and operating frequency band. In the example of FIG. 2, the PSS 204 is positioned within the first OFDM symbol of the SSB format 200 and occupies 127 subcarriers. The PSS 204 utilizes Zadoff-Chu sequences with length 127, where three different root indices (29, 34, and 25) correspond to PCI values modulo 3, enabling UEs to determine partial cell identity information during initial synchronization. The PSS 204 sequence is mapped to subcarriers 56 through 182 within the 240-subcarrier SSB bandwidth, with guard subcarriers on both sides to minimize interference with adjacent frequency allocations.

The SSS 206 is located within the third OFDM symbol and similarly spans 127 subcarriers. The SSS 206 frequency allocation includes 8 unused subcarriers positioned below the SSS 206 and 9 unused subcarriers positioned above the SSS 206 within the same OFDM symbol. The SSS 206 employs Gold sequences of length 127 that are generated using two m-sequences with different initialization parameters derived from the PCI, enabling UEs to determine the complete PCI value when combined with PSS 204 information. The SSS 206 sequence provides 336 unique cell identity groups, and the asymmetric guard band allocation (8 subcarriers below, 9 subcarriers above) may accommodate implementation-specific filtering requirements and reduce inter-symbol interference.

The PBCH 208 utilizes a distributed resource allocation pattern, occupying two complete OFDM symbols (e.g., the second and fourth symbols) with full 240-subcarrier coverage, and additionally occupying 48 subcarriers positioned below and above the SSS 206 within the third OFDM symbol. This distributed allocation results in the PBCH 208 occupying a total of 576 subcarriers across three OFDM symbols (240+48+48+240=576). PBCH demodulation reference signals (DMRSs) occupy 144 REs, which is one-fourth of the total REs, with the remaining REs allocated for the PBCH payload (576−144=432 REs). The distributed PBCH 208 allocation enables frequency diversity across the SSB bandwidth and may improve reception reliability in frequency-selective fading channels. The PBCH 208 carries a 32-bit payload that undergoes channel coding, rate matching, and scrambling operations before modulation using quadrature phase shift keying (QPSK). The DMRS are embedded within the PBCH 208 REs to enable channel estimation and coherent demodulation at the UE receiver.

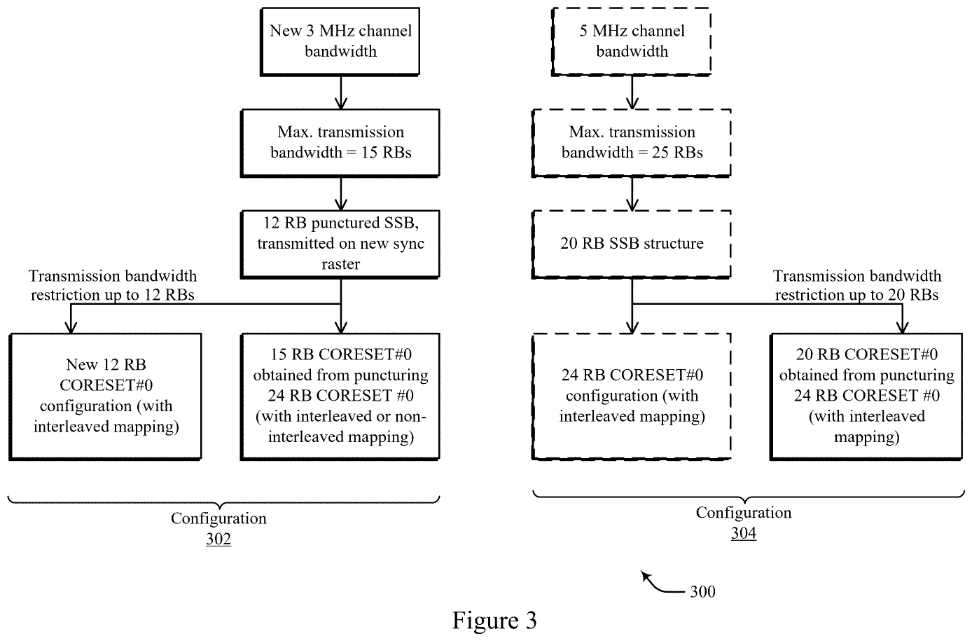

FIG. 3 illustrates an example of configuration options 300 for common channels in accordance with aspects of the present disclosure. In some examples, the configuration options 300 implement or are implemented by aspects of the wireless communications system 100. The configuration options 300 illustrate design paths for SSB and CORESET0 configurations across different channel bandwidths.

In contrast to LTE, which supports channel bandwidths as small as 1.4 MHz, 5G NR was designed for larger spectrum allocations up to 100 MHz in FR1, corresponding to frequencies below 6 GHz, and conventionally supported a minimum channel bandwidth of 5 MHz. This design characteristic limits direct adoption of 5G NR in narrow spectrum allocations of less than 5 MHz, which are utilized in MCN deployments. To address this limitation, 3GPP Release 18 introduced support for 5G NR operation in channel bandwidths smaller than 5 MHz within FR1. The configuration options 300 illustrate the different design paths for common channels based on the available channel bandwidth.

Configuration 302 corresponds to a 5 MHz channel bandwidth with a maximum transmission bandwidth of 25 RBs. The 5 MHz channel bandwidth configuration supports the legacy 20 RB SSB structure without puncturing, where the SSB occupies 20 RBs in the frequency domain and 4 OFDM symbols in the time domain as described with reference to FIG. 2. The 5 MHz channel bandwidth configuration supports transmission bandwidth restrictions up to 20 RBs. A CORESET0 configuration for the 5 MHz channel bandwidth includes a 24 RB CORESET0 configuration with interleaved control channel element (CCE) to RE group (REG) mapping, or a 20 RB CORESET0 obtained from puncturing a 24 RB CORESET0 with interleaved CCE-to-REG mapping. The 5 MHz channel bandwidth configuration represents the legacy 5G NR design and is applicable to devices that support a minimum spectrum allocation of 5 MHz or greater.

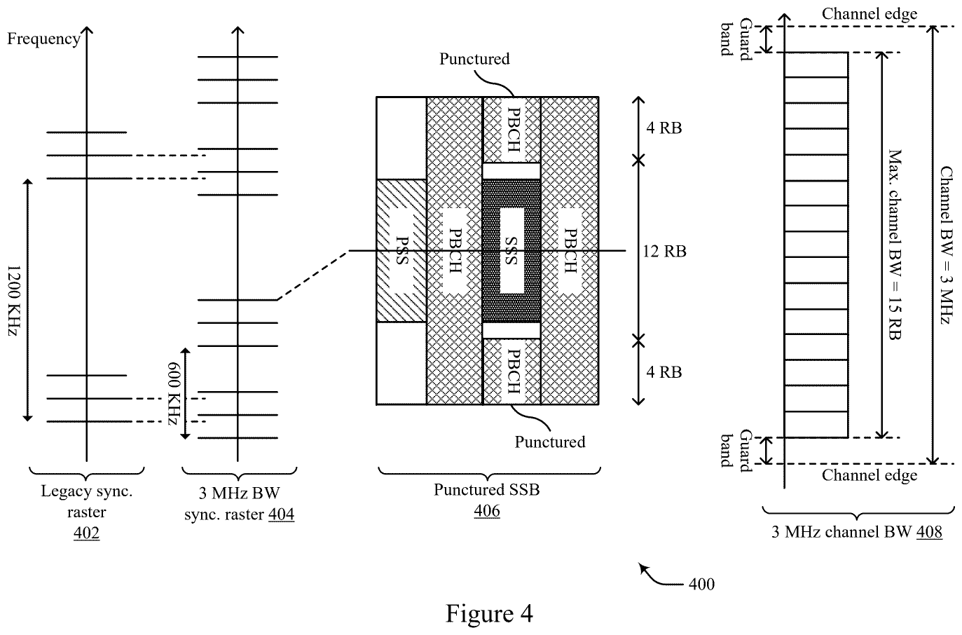

Configuration 304 corresponds to a 3 MHz channel bandwidth with a maximum transmission bandwidth of 15 RBs. The 3 MHz channel bandwidth cannot accommodate the legacy 20 RB SSB structure, and the SSB is punctured to fit within the available transmission bandwidth. The 3 MHz channel bandwidth configuration supports a 12 RB punctured SSB transmitted over a dedicated synchronization raster. The 12 RB punctured SSB is obtained by removing 4 RBs from an upper frequency edge and 4 RBs from a lower frequency edge of the legacy 20 RB SSB structure, as described with reference to FIG. 4. The 3 MHz channel bandwidth configuration supports transmission bandwidth restrictions up to 12 RBs. A CORESET0 configuration for the 3 MHz channel bandwidth includes a 12 RB CORESET0 configuration with interleaved or non-interleaved CCE-to-REG mapping, or a 15 RB CORESET0 obtained from puncturing a 24 RB CORESET0 with interleaved or non-interleaved CCE-to-REG mapping. The 3 MHz channel bandwidth configuration was introduced in 3GPP Release 18 to support RedCap devices, eRedCap devices, and MCN deployments.

A synchronization raster defines frequency positions where a UE scans for an SSB during initial cell search. Separate synchronization rasters are defined for the 3 MHz channel bandwidth and the 5 MHz channel bandwidth. The synchronization raster for the 3 MHz channel bandwidth has approximately twice the granularity of the synchronization raster for the 5 MHz channel bandwidth, providing deployment flexibility in narrow spectrum deployments. The 3 MHz channel bandwidth synchronization raster has a raster spacing of 600 kHz, while the synchronization raster for channel bandwidths above 3 MHz has a raster spacing of 1200 kHz. The finer granularity of the 3 MHz synchronization raster enables more precise frequency positioning of the SSB within the narrow spectrum allocation. Band n100 supports special synchronization raster points dedicated to 12 RB and 20 RB transmission bandwidths within 3 MHz and 5 MHz channel bandwidths, respectively.

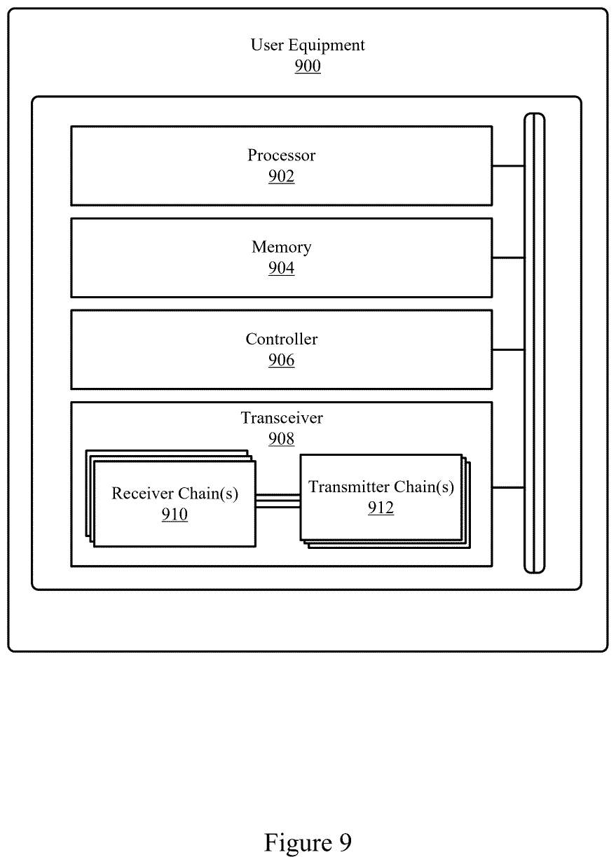

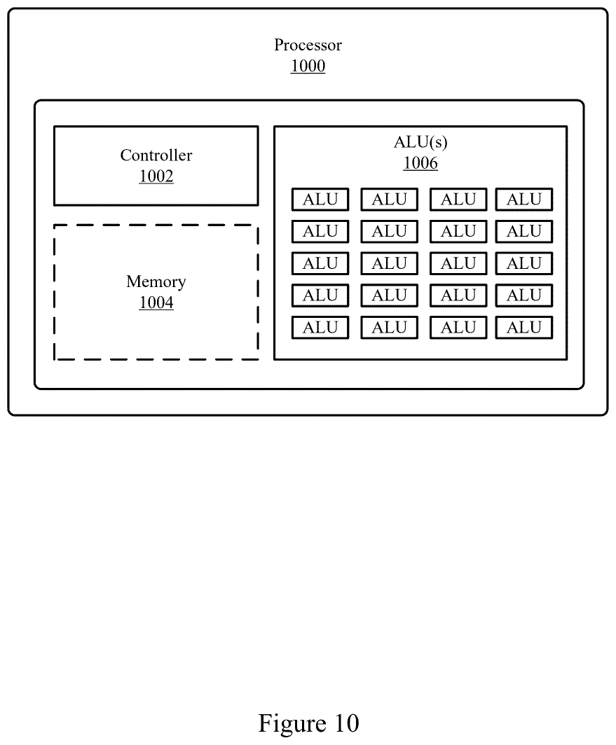

The configuration options 300 illustrate that different channel bandwidths result in different SSB structures and CORESET0 configurations. The 3 MHz configuration path requires puncturing of the SSB to fit within the narrower bandwidth, while the 5 MHz configuration path accommodates the full 20 RB SSB structure. The techniques described herein with reference to FIGS. 9 and 10 address the performance degradation caused by RB-level puncturing of the SSB in the 3 MHz configuration path through channel interleaving and rate matching pattern selection.

FIG. 4 illustrates an example synchronization raster and SSB configuration 400 in accordance with aspects of the present disclosure. In some examples, the synchronization raster and SSB configuration 400 implements or is implemented by aspects of the wireless communications system 100. For example, the synchronization raster and SSB configuration 400 may be implemented by a UE or an NE, which may be examples of a UE 104 and an NE 102 as described with reference to FIG. 1.

A synchronization raster indicates frequency positions of an SSB that can be used by a UE for system acquisition when explicit signaling of the SSB position is not present. A global synchronization raster is defined for all frequencies. A frequency position of the SSB is defined as a synchronization signal reference frequency (SSREF) with a corresponding global synchronization channel number (GSCN). The SSREF defines a reference frequency for the SSB, and the GSCN is an integer index that uniquely identifies each frequency position on the synchronization raster. GSCN values are assigned sequentially across the frequency range, with different GSCN ranges corresponding to different frequency bands and synchronization raster configurations. The GSCN enables standardized reference to specific SSB locations across different network deployments and frequency bands.

The synchronization raster and subcarrier spacing of the SSB are defined separately for each operating band. The synchronization raster provides a structured approach for UEs to efficiently search for SSBs without requiring prior knowledge of the exact SSB frequency location. During initial access, rather than scanning the entire frequency spectrum, a UE searches at discrete frequency positions defined by a synchronization raster, which reduces the time and computational resources required for initial cell search.

Synchronization raster design accounts for a minimum channel bandwidth supported by a wireless communications system. A legacy synchronization raster was designed for a minimum channel bandwidth of 5 MHz, with a raster spacing of 1200 kHz for frequencies below 3000 MHz. A 3 MHz channel bandwidth introduced in 3GPP Release 18 required a dedicated synchronization raster with finer granularity, having a raster spacing of 600 kHz to provide sufficient deployment flexibility in narrow spectrum allocations. The finer granularity of the 3 MHz synchronization raster enables more precise positioning of the SSB within the reduced channel bandwidth while maintaining adequate separation between adjacent synchronization raster points.

FIG. 4 depicts a legacy synchronization raster 402, a 3 MHz bandwidth synchronization raster 404, a punctured SSB 406, and a 3 MHz channel bandwidth 408. The legacy synchronization raster 402 corresponds to channel bandwidths above 3 MHz, such as 5 MHz, 10 MHz, and larger channel bandwidths. The 3 MHz bandwidth synchronization raster 404 corresponds to the 3 MHz channel bandwidth 408 introduced in 3GPP Release 18 to support RedCap devices, eRedCap devices, and MCN deployments.

The legacy synchronization raster 402 has a raster spacing of 1200 kHz for a frequency range of 0 to 3000 MHz. Parameters defining the SSREF and the GSCN for the legacy synchronization raster 402 are specified in Table 1 below. For the frequency range of 0 to 3000 MHz, an SS block frequency position SSREF is defined as N×1200 kHz+M×50 kHz, where N=1, 2, . . . , 2499 and M∈{1,3,5}. A corresponding GSCN is calculated as 3N+(M−3)/2, with a GSCN range of 2 to 7498. For a frequency range of 3000 to 24250 MHz, the SS block frequency position SSREF is defined as 3000 MHz+N×1.44 MHz, where N=0, 1, . . . , 14756. The corresponding GSCN is calculated as 7499+N, with a GSCN range of 7499 to 22255. The default value for operating bands which only support SCS-spaced channel raster(s) is M=3.

TABLE 1
GSCN parameters for the global frequency
raster for above 3 MHz channel bandwidth

| | SS Block frequency | | Range |
|---|---|---|---|
| Frequency range | position SSREF | GSCN | of GSCN |
| 0-3000 MHz | N * 1200 kHz + | 3N + | 2²-7498 |
| | M * 50 kHz, | (M − 3)/2 | |
| | N = 1:2499, M ∈ {1, 3, 5} | | |
| 3000-24250 MHz | 3000 MHz + N * 1.44 MHz | 7499 + N | 7499-22255 |
| | N = 0:14756 | | |

Table 1: GSCN parameters for the global frequency raster for above 3 MHz channel bandwidth

The 3 MHz bandwidth synchronization raster 404 has a raster spacing of 600 kHz, which is approximately twice the granularity of the legacy synchronization raster 402. The finer granularity provides deployment flexibility in narrow spectrum deployments by enabling more precise frequency positioning of the SSB within the 3 MHz channel bandwidth 408. Parameters defining the SSREF and the GSCN for the 3 MHz bandwidth synchronization raster 404 are specified in Table 2 below. For a frequency range of 0 to 1000 MHz, an SS block frequency position SSREF is defined as N×600 KHz+M×50 kHz+300 kHz, where N=1, 2, . . . , 1665 and M∈{1,3,5}. A corresponding GSCN is calculated as 26638+3N+(M−3)/2, with a GSCN range of 26640 to 31634. The 3 MHz channel bandwidth configuration is applicable for a 15 RB transmission bandwidth configuration with the punctured SSB 406.

TABLE 2
GSCN parameters for the global frequency
for 3 MHz channel bandwidth

| Range of | | | |
|---|---|---|---|
| frequencies | SS block frequency | | Range of |
| (MHz) | position SSREF | GSCN | GSCN |
| 0-1000 | N * 600 kHz + M * | 26638 + 3N + | 26640-31634 |
| | 50 kHz + 300 kHz, | (M − 3)/2 | |
| | N = 1:1665, M ∈ {1, 3, 5} | | |

Table 2: GSCN parameters for the global frequency for 3 MHz channel bandwidth

The 3 MHz bandwidth synchronization raster 404 is offset from the legacy synchronization raster 402 such that frequency positions of the 3 MHz bandwidth synchronization raster 404 do not overlap with frequency positions of the legacy synchronization raster 402. This offset prevents legacy devices operating on the legacy synchronization raster 402 from detecting or accessing a cell operating with the 3 MHz channel bandwidth 408. Devices that support the 3 MHz channel bandwidth 408 scan the 3 MHz bandwidth synchronization raster 404 to locate the SSB, while devices that support channel bandwidths of 5 MHz or greater scan the legacy synchronization raster 402.

The 3 MHz channel bandwidth 408 supports a maximum transmission bandwidth of 15 RBs. A legacy 20 RB SSB structure cannot fit within the 3 MHz channel bandwidth 408, and the SSB is punctured to obtain the punctured SSB 406. The punctured SSB 406 includes 12 RBs in the frequency domain, which is obtained by removing 4 RBs from an upper frequency edge and 4 RBs from a lower frequency edge of the legacy 20 RB SSB structure. The punctured SSB 406 is transmitted and received on the 3 MHz bandwidth synchronization raster 404.

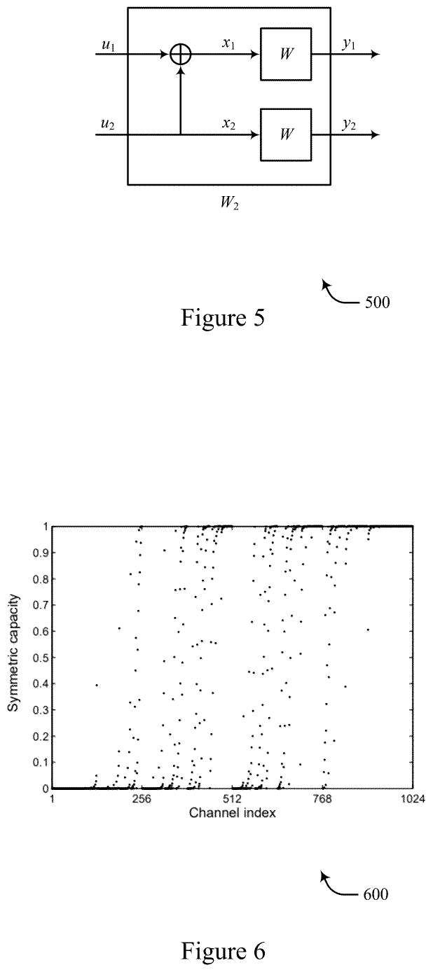

FIG. 5 illustrates an example channel combining diagram 500 in accordance with aspects of the present disclosure. In some examples, the channel combining diagram 500 implements or is implemented by aspects of the wireless communications system 100. For example, the channel combining diagram 500 may be implemented by a UE or an NE, which may be examples of a UE 104 and an NE 102 as described with reference to FIG. 1. For example, an NE may implement the channel combining diagram 500 as part of polar encoding for PBCH transmissions, as described herein.

Polar codes are forward error correction codes that achieve channel capacity with explicit construction and low complexity encoding and decoding. Polar codes utilize a concept referred to as channel polarization, which transforms N independent copies of a binary-input discrete memoryless channel (B-DMC) W into a second set of N synthesized channels that exhibit a polarization effect. As N increases, the symmetric capacity of each synthesized channel tends toward either 0 or 1 for all but a vanishing fraction of channels. This polarization effect creates two distinct sets of bit-channels: a first set of reliable bit-channels having symmetric capacity approaching 1, and a second set of unreliable bit-channels having symmetric capacity approaching 0.

Channel polarization includes a channel combining phase and a channel splitting phase. The channel combining phase combines copies of a B-DMC Win a recursive manner to produce a vector channel W_{N}:X_{N}→Y_{N}, where N is a power of two such that N=2ⁿ for n≥0. The recursion begins at the 0th level with one copy of W, where W₁≙W. The first level of the recursion combines two independent copies of W₁ to obtain the combined vector channel W₂ with transition probabilities W₂ (y₁, y₂|u₁, u₂)=W(y₁⊕u₁⊕u₂)W (y₂|u₂). As illustrated in FIG. 5, the first input bit u₁ and the second input bit u₂ are combined through an XOR operation to produce the first encoded bit x₁, while the second input bit u₂ passes through directly to produce the second encoded bit x₂. The first encoded bit x₁ is provided to a first instance of channel W, which produces the first channel output y₁. The second encoded bit x₂ is provided to a second instance of channel W, which produces the second channel output y₂.

FIG. 6 illustrates an example channel polarization 600 in accordance with aspects of the present disclosure. In some examples, the channel polarization 600 implements or is implemented by aspects of the wireless communications system 100. For example, the channel polarization 600 may be implemented by a UE or an NE, which may be examples of a UE 104 and an NE 102 as described with reference to FIG. 1. For example, an NE may utilize the channel polarization 600 to determine bit-channel reliabilities for polar encoding of PBCH payloads, as described herein.

Polar encoding assigns data sequence indices to two different sets prior to transmission. A first set includes indices corresponding to reliable bit-channels, which carry information bits. A second set includes indices corresponding to unreliable bit-channels, which carry frozen bits that are known to both the encoder and decoder. The polar sequence defines which bit positions correspond to reliable bit-channels and which bit positions correspond to unreliable bit-channels based on bit-channel reliabilities. Information bits and parity bits are assigned to reliable bit-channels, and frozen bits are assigned to unreliable bit-channels. Polar code construction may be performed using techniques based on Bhattacharyya parameter bounds, density evolution, or Gaussian approximation, among other approaches.

Polar decoding may be performed using successive cancellation (SC) decoding, SCL decoding, log-likelihood ratio (LLR) based SCL, or belief propagation decoding. SCL decoding maintains a list of candidate decoding paths and may achieve maximum likelihood performance for a sufficiently large list size. CRC-aided polar codes concatenate a CRC with the polar code to enable error detection and path selection during SCL decoding. A polar decoder may set reliabilities of punctured bit positions to zero and perform SCL decoding with cyclic redundancy check assistance, as described herein.

For any B-DMC W, the channels

$$\{ {W}_{N}^{( i )} \}$$

polarize in the sense that, for any fixed δ∈(0, 1), as N goes to infinity through powers of two, the fraction of indices i∈{1, . . . , N} for which I

$$( {W}_{N}^{( i )} )$$

∈(1−δ, 1] goes to I(W) and the fraction for which I

$$( {W}_{N}^{( i )} )$$

∈[0,δ) goes to 1−I(W). These polarization effects are illustrated in FIG. 6.

More specifically, the channel polarization 600 includes a scatter plot illustrating the distribution of symmetric capacity values across channel indices resulting from the channel polarization process described with reference to FIG. 5. The scatter plot depicts symmetric capacity on the vertical axis, ranging from 0 to 1, and channel index on the horizontal axis, ranging from 1 to 1024. The distribution of data points demonstrates the polarization effect that occurs when the channel combining and splitting operations of FIG. 5 are applied recursively. A first concentration of data points appears near a symmetric capacity of 1, representing reliable bit-channels that are suitable for carrying information bits and parity bits. A second concentration of data points appears near a symmetric capacity of 0, representing unreliable bit-channels that are assigned frozen bits. Relatively few data points occupy intermediate symmetric capacity values between 0 and 1, illustrating that the recursive application of the channel combining structure of FIG. 5 causes the synthesized bit-channels to split into two distinct groups rather than remaining at moderate reliability levels.

A polar sequence defines which bit positions correspond to reliable bit-channels and which bit positions correspond to unreliable bit-channels based on the symmetric capacity values. Each bit-channel of N bit-channels has a corresponding reliability metric that quantifies whether the bit-channel is reliable or unreliable. Information bits are assigned to bit positions corresponding to reliable bit-channels having symmetric capacity approaching 1. Frozen bits, which are bits known to both the encoder and decoder and are typically set to zero, are assigned to bit positions corresponding to unreliable bit-channels having symmetric capacity approaching 0. The polar sequence is defined in technical specifications (e.g., preconfigured) and determines the assignment of information bits and frozen bits to the respective bit-channel positions.

When puncturing is performed at the RB level without consideration of the polar sequence, the puncturing may remove REs corresponding to reliable bit-channels carrying information bits or parity bits. This removal of reliable bit-channels negatively impacts the performance of the polar decoder at the receiver. The techniques described herein, including channel interleaving and rate matching pattern selection, address this issue by ensuring that puncturing operations remove bits corresponding to unreliable bit-channels carrying frozen bits rather than bits corresponding to reliable bit-channels carrying information bits or parity bits.

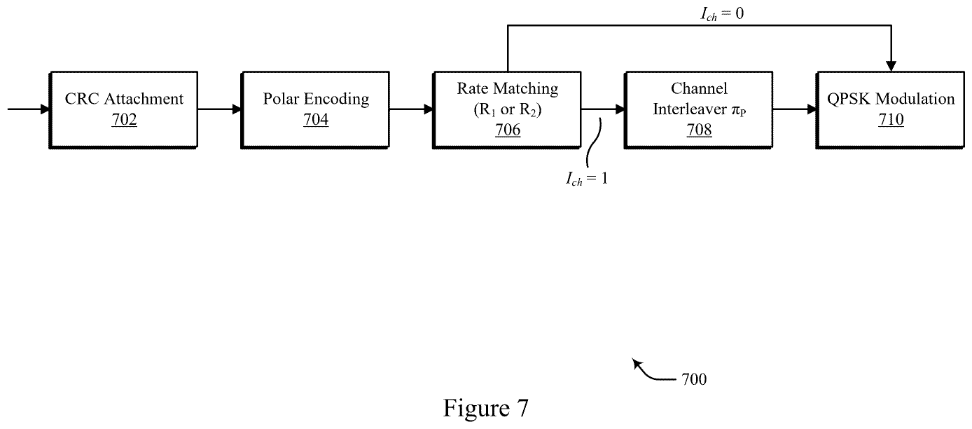

FIG. 7 illustrates an example encoding chain 700 in accordance with aspects of the present disclosure. In some examples, the encoding chain 700 implements or is implemented by aspects of the wireless communications system 100. For example, the encoding chain 700 may be implemented by a transmitting device, such as a UE or an NE, which may be examples of a UE 104 and an NE 102 as described with reference to FIG. 1. For example, an NE may implement the encoding chain 700 to encode and transmit an SSB with channel interleaving, as described herein.

The encoding chain 700 includes a CRC attachment 702, a polar encoding 704, a rate matching 706, a channel interleaver 708, and a QPSK modulation 710. The CRC attachment 702 receives a PBCH payload, which carries an MIB containing system parameters for initial access, and appends CRC bits to enable error detection at a receiver. The PBCH payload corresponds to the MIB and has an information bit size of 32 bits. The polar encoding 704 encodes the combined payload and CRC bits using a polar encoder corresponding to a polar code construction based on a nested polar sequence to generate a polar codeword, where the polar sequence defines which bit positions correspond to reliable bit-channels and which bit positions correspond to unreliable bit-channels. The polar codeword is provided to a sub-block interleaver, then to the rate matching 706, then through the channel interleaver 708 with a pre-defined interleaving pattern, and then to the QPSK modulation 710. The channel interleaver 708 may be added to the PBCH encoding chain in a manner similar to an uplink control channel. The QPSK modulation 710 modulates output bits onto symbols for transmission over an air interface.

The channel interleaver 708 is positioned between the rate matching 706 and the QPSK modulation 710 and is enabled or disabled by the NE based on a carrier channel bandwidth used for transmission of the SSB. Depending on the carrier channel bandwidth, the SSB transmission bandwidth is adjusted to fit within the carrier channel bandwidth. The SSB is rate-matched if the bandwidth of the SSB is less than the carrier channel bandwidth, or the SSB is punctured if the bandwidth of the SSB is greater than the carrier channel bandwidth. For example, the NE may enable the channel interleaver 708 when the carrier channel bandwidth is less than 5 MHz (e.g., 3 MHz), in order to ensure that puncturing the SSB (e.g., to fit within the 3 MHz bandwidth) does not result in reduced performance. Additionally, or alternatively, the NE may enable the channel interleaver when the carrier channel bandwidth is less than the transmission bandwidth of the SSB. The NE may disable (or refrain from enabling) the channel interleaver 708 when the carrier channel bandwidth is 5 MHz or greater, and/or when the carrier channel bandwidth is equal to or greater than the transmission bandwidth of the SSB. In some examples, one interleaving pattern is defined for the channel interleaver 708, and the interleaving pattern is applied over the polar encoding output according to pre-defined rules as shown below:
If carrier BW=5 Mhz≥SSB BW then
If (Output sequence length E=E_{5 Mhz}) && (I_{ch}=0)
Then break;
Else if carrier BW=3 Mhz or carrier BW<SSB BW
If (Output sequence length E=E_{3 Mhz}) && (I_{ch}=1)
Then Interleaving_pattern=π_{P}

y=π_{P}(x)

In some examples, an interleaving flag I_{ch} indicates the activation or deactivation of the channel interleaver 708 for the encoding chain 700. When the channel interleaver 708 is disabled, the NE may set I_{ch} to 0. When the channel interleaver 708 is enabled, the NE may set I_{ch} to 1, and the channel interleaver 708 applies the interleaving pattern π_{P} to the rate-matched sequence, such that the output y=π_{P}(x), where x is the input sequence and y is the interleaved output sequence.

The channel interleaver 708 may be configured based on the polar sequence, including a set of frozen bits S_{F} and a set of information bits S_{I}, to perform bit reordering. In some implementations, the channel interleaver 708 may be configured with two or more pre-defined interleaving patterns and may select the interleaving pattern from a set of channel interleaving patterns, such as based on a quantity of RBs available for transmission of the SSB or based on the carrier channel bandwidth. The interleaving pattern may be a pre-defined permutation configured to map polar bits corresponding to reliable bit-channels to REs that are preserved when adjusting the SSB to fit within the carrier channel bandwidth. The polar codeword bits transmitted over reliable synthesized channels are rearranged such that these bits are mapped to the center of the SSB resource grid, and the polar codeword bits transmitted over unreliable synthesized channels are rearranged such that these bits are mapped to the upper and lower frequency edges of the SSB resource grid.

For example, when the channel interleaver 708 is enabled, the channel interleaver 708 reorders bits of the polar codeword to map bits corresponding to frozen bit positions in the polar sequence to REs in an upper frequency edge, a lower frequency edge, or both an upper frequency edge and a lower frequency edge of the SSB, and to map bits corresponding to information bit positions and parity bit positions in the polar sequence to REs at a center frequency region of the SSB. For a 12 RB punctured SSB, the bits corresponding to frozen bit positions are mapped to the 4 RBs corresponding to 48 subcarriers at the upper frequency edge and the 4 RBs corresponding to 48 subcarriers at the lower frequency edge. This reordering ensures that when the SSB is punctured to fit within the carrier channel bandwidth, the punctured REs correspond to frozen bits transmitted over unreliable bit-channels rather than information bits or parity bits transmitted over reliable bit-channels. The RB-level puncturing of the PBCH thus does not impact the reliable bit-channels, and performance of a polar decoder at a receiving device (e.g., a UE) does not degrade as compared to RB-level puncturing performed without prior bit rearrangement. The applied interleaving pattern enables the puncturing of frozen bits corresponding to unreliable bit-channels instead of impacting reliable bit-channels carrying information bits or parity bits that are utilized for CRC-aided polar decoding.

Subsequent to QPSK modulation 710, the NE transmits the SSB including the PBCH payload over a synchronization raster within the carrier channel bandwidth. The UE receives the SSB over the synchronization raster and determines whether to enable channel de-interleaving when decoding, e.g., as part of a receiver chain such as a decoding chain. In some examples, the UE makes this decision based on the carrier channel bandwidth, e.g., by detecting the carrier channel bandwidth. For instance, if the carrier channel bandwidth is less than 5 MHz and/or is less than the transmission bandwidth of the SSB, the UE may enable channel de-interleaving. The UE may disable (or refrain from enabling) the channel de-interleaver when the carrier channel bandwidth is 5 MHz or greater, and/or when the carrier channel bandwidth is equal to or greater than the transmission bandwidth of the SSB.

The UE decodes received PBCH codewords using a CRC-aided SCL list decoder, where reliabilities associated with punctured bits according to a rate matching pattern are set to zero, which corresponds to unreliable bit-channels. When channel de-interleaving is enabled, the UE applies channel de-interleaving to received bits of the SSB to generate de-interleaved bits. The channel de-interleaving corresponds to an inverse of the channel interleaving pattern π_{P} applied at the NE. The receiver chain includes a channel de-interleaver that reverses the reordering performed by the channel interleaver 708 at the NE. The UE may set the value of the flag I_{ch} according to whether the channel de-interleaver is enabled or disabled. The UE decodes, using a polar decoder, the PBCH payload based on the de-interleaved bits. A CRC-aided polar decoder may perform tree traversal decoding using the polar sequence, including the set of frozen bits S_{F} and the set of information bits S_{I}.

A single synchronization raster design or a dual synchronization raster design may be supported for common channels. The design of common channels such as the SSB and physical downlink control channel (PDCCH) may be unified for different carrier channel bandwidths with the assumption of a minimum bandwidth of 3 MHz. In a dual synchronization raster configuration, a first synchronization raster is associated with a first carrier channel bandwidth, such as 3 MHz, and a second synchronization raster is associated with a second carrier channel bandwidth greater than the first carrier channel bandwidth, such as 5 MHz. The NE uses the first synchronization raster for SSB transmission if the carrier channel bandwidth corresponds to the first bandwidth and the second synchronization raster if the carrier channel bandwidth corresponds to the second bandwidth.

In some examples, the UE may be unable to determine or otherwise detect the carrier channel bandwidth. The UE may determine whether to enable or disable the channel de-interleaver based on the synchronization raster over which the SSB is received. For instance, use of the synchronization raster dedicated to the first carrier channel bandwidth indicates to the UE that the channel interleaving pattern π_{P} was applied at the NE, and thus, to successfully decode the SSB, the UE enables the channel de-interleaver (e.g., applies the inverse of the channel interleaving pattern π_{P} over the polar codeword when performing polar decoding of the PBCH payload). Use of the legacy synchronization raster designed for the second carrier channel bandwidth indicates to the UE that the channel interleaver can be deactivated and no interleaving pattern is to be applied to the received bits when performing polar decoding of the PBCH payload.

In a single synchronization raster configuration, one synchronization raster is designed for a minimum spectrum allocation of 3 MHz. That is, the same synchronization raster is used for carrier channel bandwidths of 3 MHz and for carrier channel bandwidths above 3 MHz. A single synchronization raster may be configured with parameters defining SSREF and GSCN for all frequency ranges starting from a 3 MHz channel bandwidth and above, such as 5 MHz or 10 MHz.

Table 3 specifies GSCN parameters for the global frequency raster for 3 MHz and above channel bandwidths in a single synchronization raster design. For the frequency range of 0 to 3000 MHz, the SS block frequency position SSREF is defined as N×Rₛₚ KHz+M×50 kHz, where Rₛₚ is the raster spacing. The corresponding GSCN is calculated as 26638+3N+(M−3)/2. For the frequency range of 3000 to 24250 MHz, the SS block frequency position SSREF is defined as 3000 MHz+N×1.44 MHz. The corresponding GSCN is calculated as 7499+N, with a GSCN range of 7499 to 22255. The raster spacing Rₛₚ is finer than the raster spacings used in legacy synchronization raster designs and is a common divisor of 3 MHz and 5 MHz, enabling the single synchronization raster to support both the first carrier channel bandwidth and the second carrier channel bandwidth.

TABLE 3
GSCN parameters for the global frequency
for 3 MHz and above channel bandwidth

| Range of | | | |
|---|---|---|---|
| frequencies | SS block frequency | | Range of |
| (MHz) | position | GSCN | GSCN |
| 0-3000 MHz | N*Rₛₚ khz + | 26638 + 3N + | Range New |
| | M*50 khz | (M − 3)/2 | Raster |
| 3000-24250 MHz | 3000 Mhz + | 7499 + N | 7499-22255 |
| | N*1.44 Mhz | | |

Table 3: GSCN parameters for the global frequency for 3 MHz and above channel bandwidth

When the single synchronization raster is used for both the first carrier channel bandwidth and the second carrier channel bandwidth, the UE may not inherently know which carrier channel bandwidth is being used based on the synchronization raster alone. The exact carrier channel bandwidth, such as 3 MHz or 5 MHz, may be deduced from different raster pre-configurations, and based on the detected carrier channel bandwidth, the channel de-interleaving is enabled. In some examples, the carrier channel bandwidth location may be pre-configured within the frequency range using the corresponding channel or synchronization raster.

Alternatively, the NE may implicitly signal the carrier channel bandwidth to the UE via a PCI used for PSS and SSS generation. A first set of PCIs S₁ may correspond to a first carrier channel bandwidth, such as 5 MHz, and a second set of PCIs S₂ may correspond to a second carrier channel bandwidth, such as 3 MHz. The NE generates, using a PCI corresponding to the carrier channel bandwidth in which the SSB is to be transmitted, a PSS and an SSS included in the SSB, such that the PCI indicates the carrier channel bandwidth. The UE detects the PCI from the PSS, the SSS, or both the PSS and the SSS in the SSB. When the UE detects a PCI belonging to the first set S₁, the UE determines that the carrier channel bandwidth is 5 MHz and thus disables channel de-interleaving. When the UE detects a PCI belonging to the second set S₂, the UE determines that the carrier channel bandwidth is 3 MHz and enables channel de-interleaving.

In some implementations, different frequency positions on the single synchronization raster correspond to different bandwidths associated with the SSB. The single synchronization raster defines a set of candidate frequency positions where the UE may detect the SSB during initial cell search. In the single synchronization raster configuration, the frequency positions are partitioned such that a first subset of frequency positions corresponds to the first carrier channel bandwidth and a second subset of frequency positions corresponds to the second carrier channel bandwidth. The NE transmits the SSB at a frequency position corresponding to the carrier channel bandwidth. The frequency position at which the SSB is transmitted indicates the carrier channel bandwidth to the UE. When the UE detects the SSB at a frequency position belonging to the first subset, the UE determines that the carrier channel bandwidth corresponds to the first bandwidth and configures the channel de-interleaver and/or rate matching accordingly. When the UE detects the SSB at a frequency position belonging to the second subset, the UE determines that the carrier channel bandwidth corresponds to the second bandwidth and configures the channel de-interleaver and/or rate matching accordingly. This approach enables the UE to implicitly determine the carrier channel bandwidth based on the detected frequency position of the SSB without requiring explicit signaling of the bandwidth in the PBCH payload.

In some implementations, depending on the carrier channel bandwidth, both rate matching pattern adaptation and channel interleaver activation or deactivation may be performed to enhance PBCH coverage. In such examples, the rate matching 706 and the channel interleaver 708 may operate in parallel, and both blocks may follow the same activation or deactivation rules (e.g., based on the carrier channel bandwidth).

For example, the NE may, depending on the minimum spectrum allocation configuration, enable a rate matching selection procedure and the activation or deactivation of channel interleaving, such as in deep coverage scenarios or when channel conditions are poor. The rate matching 706 adjusts a number of coded bits to fit available transmission resources based on the carrier channel bandwidth. Multiple rate matching patterns may be configured, such as a first rate matching pattern R₁ that corresponds to a legacy rate matching pattern (e.g., for 5 MHz and above channel bandwidths) and a second rate matching pattern R₂ that corresponds to a separate rate matching pattern for reduced carrier channel bandwidths (e.g., 3 MHz). The second rate matching pattern R₂ may be understood or referred to as a bit-level rate matching pattern.

The NE may determine which rate matching pattern to use for encoding an SSB based on the carrier channel bandwidth to be used for transmitting the SSB. For example, when the carrier channel bandwidth is equal to or greater than a transmission bandwidth of the SSB, such as a 5 MHz or greater carrier channel bandwidth, the NE selects the first rate matching pattern R₁. In this case, the rate matching 706 produces an output sequence length of E₁ bits, and the rate matching 706 repeats bits of the polar codeword to obtain a rate-matched sequence having the output sequence length. The NE may also disable the channel interleaver. When the carrier channel bandwidth is less than the bandwidth of the SSB, such as 3 MHz, the NE selects the second rate matching pattern R₂ and enables the channel interleaver. Here, the output sequence length is E₂, and the rate matching 706 punctures the polar codeword to obtain a rate-matched sequence having the output sequence length, where the output sequence length E₂ for the second rate matching pattern R₂ is less than the output sequence length E₁ for the first rate matching pattern R₁.

When a puncturing pattern at the NE does not account for the polar sequence during bit-level puncturing, the bit-channels corresponding to information bits or parity bits such as parity check bits or CRC bits become unreliable, which results in performance degradation of approximately 10 dB coverage loss. When RB-level puncturing does not impact the reliable bit-channels and is performed according to the polar reliability sequence, the decoder performance is not impacted by the puncturing, and the design with the channel interleaver 708 provides improved link performance.

Simulation results demonstrate the BLER performance for different PBCH puncturing schemes. The simulation evaluates PBCH performance when reducing the channel bandwidth from 5 MHz to 3 MHz while maintaining the same number of PBCH symbols. In this configuration, 4 RBs are removed from the upper frequency edge of the resource grid and 4 RBs are removed from the lower frequency edge, directly impacting the PBCH sequence and the polar encoding and decoding procedures. The simulation assumes 20 RBs for the SSB bandwidth and 12 RBs for the punctured SSB, 2 PBCH symbols, ideal channel estimation, a tapped delay line model type C (TDL-C) propagation channel with a delay spread of 100 nanoseconds (ns), one repetition, and the channel interleaving pattern π_{P}. The baseline configuration with RB-level puncturing exhibits performance degradation because the puncturing removes REs without consideration of the polar code structure, thus removing information bits and/or parity bits needed for successful decoding at the UE. In contrast, a bit-level rate matching configuration provides approximately 6 dB gain compared to RB-level puncturing because the rate matching pattern at the bit-level accounts for the polar sequence design and bit-channel reliabilities, which results in more reliable polar decoding at the receiver and improved BLER performance. Channel interleaving provides additional performance improvement compared to the bit-level rate matching configuration due to protection against burst errors provided by the channel interleaver 708 distributing bit locations according to the pre-configured interleaving pattern.

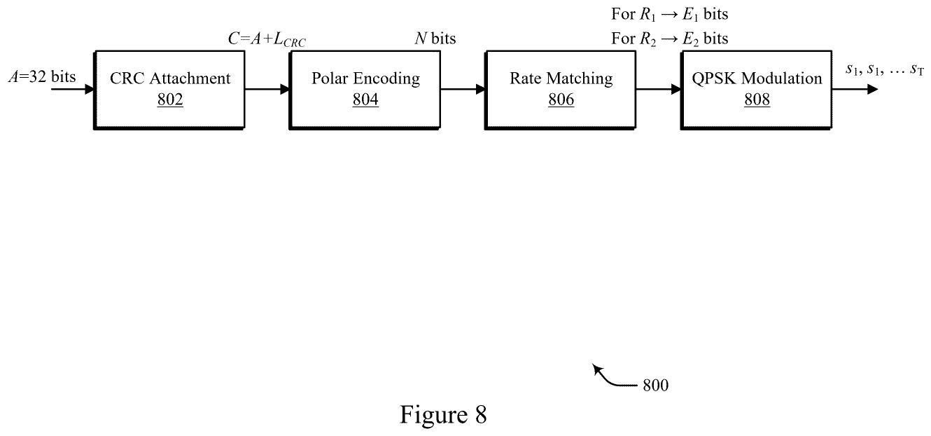

FIG. 8 illustrates an example encoding chain 800 in accordance with aspects of the present disclosure. In some examples, the encoding chain 800 implements or is implemented by aspects of the wireless communications system 100. For example, the encoding chain 800 may be implemented by a transmitting device, such as a UE or an NE, which may be examples of a UE 104 and an NE 102 as described with reference to FIG. 1. For example, an NE may implement the encoding chain 800 to encode and transmit an SSB with rate matching pattern selection, as described herein.

The encoding chain 800 includes a CRC attachment 802, polar encoding 804, rate matching 806, and QPSK modulation 808. The CRC attachment 802 receives a PBCH payload of A=32 bits corresponding to the MIB and appends CRC bits to generate an output of C=A+L_{CRC} bits. The polar encoding 804 encodes the combined payload and CRC bits according to a polar code construction based on a nested polar sequence to generate a polar codeword of N bits. The polar codeword is processed by a sub-block interleaver and provided to the rate matching 806, which performs bit-level rate matching according to a selected rate matching pattern. The rate-matched bits are provided to the QPSK modulation 808, which modulates the bits onto QPSK symbols s₁, s₂, . . . s_{T} for transmission. The encoding chain 800 does not include a channel interleaver. Instead, the rate matching 806 selects from multiple rate matching patterns based on the carrier channel bandwidth to maintain decoder performance when the SSB is adjusted to fit within a reduced carrier channel bandwidth.

In conventional implementations, the rate matching 806 applies a single rate matching pattern corresponding to a fixed payload size and code rate. When the SSB is adjusted to fit within a reduced carrier channel bandwidth such as 3 MHz, the adjustment is performed at the RE mapping stage after modulation. This RB-level puncturing removes 4 RBs from an upper frequency edge and 4 RBs from a lower frequency edge of the SSB resource grid without consideration of the polar code structure, directly impacting the PBCH sequence and resulting in degraded polar encoding and decoding performance.

In contrast, the encoding chain 800 performs puncturing at the rate matching 806, at the bit level, prior to modulation. The rate matching 806 performs repetition, puncturing, or shortening of the polar codeword. The rate matching 806 is configured with the polar sequence used by the polar encoding 804 and identifies which bit positions correspond to reliable bit-channels and which bit positions correspond to unreliable bit-channels. The rate matching 806 may puncture bit positions corresponding to unreliable bit-channels, which carry frozen bits, and preserve bit positions corresponding to reliable bit-channels, which carry information bits or parity bits. Because frozen bits are known to both the NE and the UE and are set to a predetermined value such as zero, puncturing the frozen bits does not impact polar decoding performance. The encoding chain 800 thus generates a PBCH that fits within the carrier channel bandwidth without requiring RB-level puncturing at the resource mapping stage.

In implementations, when encoding the PBCH payload, the NE may select a rate matching pattern from among a set of rate matching patterns based on the carrier channel bandwidth. For example, the NE may select a rate matching pattern based on a comparison between the carrier channel bandwidth and the bandwidth of the SSB. The set of rate matching patterns may include at least a first rate matching pattern R₁ and a second rate matching pattern R₂. When the carrier channel bandwidth is equal to or greater than the transmission bandwidth of the SSB and/or the carrier channel bandwidth is 5 MHz or greater, the NE selects the first rate matching pattern R₁. When the carrier channel bandwidth is less than the bandwidth of the SSB and/or the carrier channel bandwidth is 3 MHz, the NE selects the a second rate matching pattern R₂.

Additionally, or alternatively, the NE selects the rate matching pattern based on a quantity of available REs for the carrier channel bandwidth, an output sequence length, and/or an effective code rate, such as according to a set of rules as follows:
If carrier BW=5 Mhz≥SSB BW then
Output sequence length E=E_{5 Mhz} and Rate_Matching_pattern=R₁
Else if carrier BW=3 Mhz or carrier BW<SSB BW
Output sequence length E=E_{3 Mhz} and Rate_Matching_pattern=R₂

The NE may determine the output sequence length and the effective code rate based on the carrier channel bandwidth and may select the rate matching pattern accordingly. For instance, the NE may select a rate matching pattern based on a mother code length A, a desired output sequence length E, and a corresponding effective code rate

$${R}_{eff} = \frac{K}{E} .$$

The output sequence length E may be determined based on the quantity of available REs corresponding to the carrier channel bandwidth.

The first rate matching pattern R₁ corresponds to repetition, where the rate matching 806 repeats bits of the polar codeword to obtain a rate-matched sequence having a first sequence length E₁. The first sequence length E₁ may be 864 bits, corresponding to the legacy PBCH rate-matched sequence length. For the first rate matching pattern R₁, the rate matching 806 generates output bits according to eₖ=y_{(k mod N)} for k=0, 1, . . . , E₁−1, where y represents the polar codeword bits, N represents the polar codeword length, and E₁ represents the output sequence length.

The second rate matching pattern R₂ corresponds to bit-level puncturing, where the rate matching 806 punctures bits of the polar codeword to obtain a rate-matched sequence having a second sequence length E₂. The second sequence length E₂ is less than the first sequence length E₁ and corresponds to the reduced number of REs available for PBCH transmission within the 3 MHz carrier channel bandwidth. For the second rate matching pattern R₂, the rate matching 806 generates output bits according to eₖ=y_{k+N-E}_{₂} for k=0, 1, . . . , E₂−1, where E₂ represents the reduced output sequence length. The rate matching pattern R₂ removes bit positions from the beginning of the polar codeword, which correspond to unreliable bit-channels carrying frozen bits based on the polar sequence construction.

Subsequent to QPSK modulation 808, the NE transmits the SSB including the PBCH payload over a synchronization raster within the carrier channel bandwidth. The UE receives the SSB over the synchronization raster and determines the rate matching pattern used by the NE in order to select the corresponding rate matching pattern to use when decoding, e.g., as part of a receiver chain such as a decoding chain. In some examples, the UE makes this decision based on the carrier channel bandwidth, e.g., by detecting the carrier channel bandwidth. For instance, the UE may select the rate matching pattern R₁ if the carrier channel bandwidth is less than 5 MHz and/or is less than the transmission bandwidth of the SSB. The UE may select the rate matching pattern R₂ when the carrier channel bandwidth is 5 MHz or greater, and/or when the carrier channel bandwidth is equal to or greater than the transmission bandwidth of the SSB.

To decode received PBCH codewords, the UE employs a CRC-aided SCL decoder. For punctured bit positions corresponding to the rate matching pattern R₂, the polar decoder of the UE sets the reliabilities of the punctured bit positions to zero, indicating completely unreliable bit-channels. Because the rate matching pattern R₂ accounts for the polar sequence during bit-level puncturing, the punctured bit positions correspond to frozen bits transmitted over unreliable bit-channels, and setting the reliabilities to zero does not degrade polar decoding performance. When the puncturing pattern does not account for the polar sequence design, as in legacy configuration, bit-channels corresponding to information bits or parity bits such as parity check bits or CRC bits may be punctured, resulting in unreliable bit-channels for information or parity bits and causing performance degradation and coverage loss.

A single synchronization raster design or a dual synchronization raster design may be supported for common channels. In a dual synchronization raster configuration, a first synchronization raster is associated with a first carrier channel bandwidth, such as 3 MHz, and a second synchronization raster is associated with a second carrier channel bandwidth greater than the first carrier channel bandwidth, such as 5 MHz. The NE uses the first synchronization raster for SSB transmission if the carrier channel bandwidth corresponds to the first bandwidth and the second synchronization raster if the carrier channel bandwidth corresponds to the second bandwidth. In some examples, the UE may determine which rate matching pattern to select based on which synchronization raster the UE is configured to scan. When the UE scans the first synchronization raster associated with the first carrier channel bandwidth, the UE selects the second rate matching pattern R₂ corresponding to bit-level puncturing. When the UE scans the second synchronization raster associated with the second carrier channel bandwidth, the UE selects the first rate matching pattern R₁ corresponding to repetition.

In a single synchronization raster configuration, the UE scans a single synchronization raster that is designed for a minimum spectrum allocation corresponding to the first carrier channel bandwidth, such as 3 MHz. As described in Table 3, the single synchronization raster has a raster spacing Rₛₚ that is finer than the raster spacings used in legacy synchronization raster designs and is a common divisor of 3 MHz and 5 MHz, enabling the single synchronization raster to support both the first carrier channel bandwidth and the second carrier channel bandwidth.

In the single synchronization raster configuration, the UE may determine the carrier channel bandwidth based on parameters other than the synchronization raster. In some examples, carrier channel bandwidth information may be embedded within the SSB through PCI arrangements in the PSS and SSS. That is, the PCI used by the NE to generate the PSS and/or SSS may implicitly indicate the carrier channel bandwidth to the UE. A first set of PCIs S₁ may correspond to a first carrier channel bandwidth, such as 5 MHz, and a second set of PCIs S₂ may correspond to a second carrier channel bandwidth, such as 3 MHz. The NE generates the PSS and SSS included in the SSB using a PCI corresponding to the carrier channel bandwidth. The UE detects the PCI from the PSS and SSS and determines the carrier channel bandwidth based on whether the detected PCI belongs to the first set of PCIs S₁ or the second set of PCIs S₂. When the detected PCI belongs to the first set of PCIs corresponding to the first carrier channel bandwidth, the UE selects the second rate matching pattern R₂. When the detected PCI belongs to the second set of PCIs S₂ corresponding to the second carrier channel bandwidth, the UE 104 selects the first rate matching pattern R₁.

In some implementations, different frequency positions on the single synchronization raster correspond to different bandwidths associated with the SSB. The single synchronization raster defines a set of candidate frequency positions where the UE may detect the SSB during initial cell search. In the single synchronization raster configuration, the frequency positions are partitioned such that a first subset of frequency positions corresponds to the first carrier channel bandwidth and a second subset of frequency positions corresponds to the second carrier channel bandwidth. The NE transmits the SSB at a frequency position corresponding to the carrier channel bandwidth. The frequency position at which the SSB is transmitted indicates the carrier channel bandwidth to the UE. When the UE detects the SSB at a frequency position belonging to the first subset, the UE determines that the carrier channel bandwidth corresponds to the first bandwidth and configures the channel de-interleaver and/or rate matching accordingly. When the UE detects the SSB at a frequency position belonging to the second subset, the UE determines that the carrier channel bandwidth corresponds to the second bandwidth and configures the channel de-interleaver and/or rate matching accordingly. This approach enables the UE to implicitly determine the carrier channel bandwidth based on the detected frequency position of the SSB without requiring explicit signaling of the bandwidth in the PBCH payload.

The rate matching pattern selection described with reference to the encoding chain 800 may also apply to CORESET0 and PDCCH transmissions. The SSB is transmitted prior to any exchange between the NE and the UE, and the UE does not have information from the MIB when receiving the SSB. For SSB transmissions, the carrier channel bandwidth is indicated implicitly through PCI arrangements as described above. For PDCCH transmissions via CORESET0, the UE has established a connection with the NE and has received configuration parameters from the NE. The carrier channel bandwidth for CORESET0 may therefore be indicated explicitly within the configuration transmitted to the UE.

In a single design for common channels, the NE applies rate matching pattern selection to both SSB transmissions and PDCCH transmissions within CORESET0. The DCI carried by the PDCCH is adjusted to fit within the transmission bandwidth, which depends on the carrier channel bandwidth. For different available transmission bandwidths, the NE selects appropriate respective rate matching patterns over the DCI payload. In some implementations, the NE may signal the rate matching pattern to the UE via a dedicated DCI field comprising N bits, where N depends on a quantity of available rate matching patterns. In some implementations, the NE signals the rate matching pattern to the UE via the MIB.

The NE encodes the DCI using a first rate matching pattern Ra when the carrier channel bandwidth is equal to or greater than the DCI bandwidth, and encodes the DCI using a second rate matching pattern Rb when the carrier channel bandwidth is less than the DCI bandwidth. When the carrier channel bandwidth is less than the DCI bandwidth, the DCI is punctured at the bit level to adjust to the reduced carrier channel bandwidth or transmission bandwidth. The bit-level puncturing of the DCI follows the same principles as the bit-level puncturing of the PBCH described with reference to the rate matching 806, where the puncturing pattern accounts for the polar sequence design and removes bit positions corresponding to frozen bits transmitted over unreliable bit-channels.

The MIB provides configuration parameters for CORESET0 via an information element pdcch-ConfigSIB1, which comprises 8 bits and includes CORESET0 configuration information and searchSpaceZero information. The first 4 bits, corresponding to the most significant bits, determine a CORESET0 index indicating a number of RBs and a number of symbols used to determine the CORESET size for a Type0-PDCCH common search space. The CORESET bandwidth may be 24 RBs, 48 RBs, or 96 RBs, and the CORESET duration may be 1 symbol, 2 symbols, or 3 symbols. The last 4 bits, corresponding to the least significant bits, determine a searchSpaceZero index indicating PDCCH monitoring occasions for the UE to monitor for the Type0-PDCCH common search space.

The UE determines whether CORESET0 for the Type0-PDCCH common search space is present based on a subcarrier offset parameter K_{SSB}. For FR1, the UE 104 determines that CORESET0 is present when K_{SSB} is less than or equal to 23, and determines that CORESET0 is not present when K_{SSB} is greater than 23. For FR2, the UE determines that CORESET0 is present when K_{SSB} is less than or equal to 11, and determines that CORESET0 is not present when K_{SSB} is greater than 11.

In some implementations, the MIB includes an additional parameter indicating the CORESET0 size based on the carrier channel bandwidth. The additional parameter may comprise X bits, where X depends on a number of CORESET0 sizes supported for different carrier channel bandwidths. The UE receives the additional parameter and determines the CORESET0 size corresponding to the carrier channel bandwidth. Based on the configured CORESET0 size, the UE selects the corresponding rate matching pattern for decoding the DCI. When the CORESET0 size corresponds to a carrier channel bandwidth equal to or greater than the DCI bandwidth, the UE selects the first rate matching pattern Ra. When the CORESET0 size corresponds to a carrier channel bandwidth less than the DCI bandwidth, the UE selects the second rate matching pattern Rb.

Simulation results demonstrate the BLER performance characteristics of the encoding chain 800 compared to conventional RB-level puncturing approaches. The bit-level rate matching performed by the rate matching 806 provides improved BLER performance because the rate matching 806 accounts for the polar sequence design and bit-channel reliabilities when performing puncturing. Simulation results indicate that bit-level rate matching provides approximately 6 dB gain compared to RB-level puncturing under conditions including ideal channel estimation, a TDL-C propagation channel with 100 ns delay spread, and a single repetition of the PBCH transmission. The channel interleaving approach described with reference to FIG. 7 provides additional performance improvement compared to the bit-level rate matching approach by providing protection against burst errors in addition to preserving reliable bit-channels. In some implementations, the NE may implement both rate matching pattern selection at the rate matching 806 and channel interleaving at the channel interleaver 708 to maximize performance gains when the carrier channel bandwidth is less than the bandwidth of the SSB.

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a central processing unit (CPU), an ASIC, a field-programmable gate-array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for receiving an SSB over a synchronization raster, applying channel de-interleaving to received bits of the SSB to generate de-interleaved bits as a result of a determination to enable the channel de-interleaving based on a carrier channel bandwidth, and decoding, using a polar decoder, a PBCH payload based on the de-interleaved bits. In this manner, the UE 900 supports decoding of PBCH transmissions where channel interleaving was applied to protect reliable bit-channels from RB-level puncturing, which preserves decoder performance when the SSB is adjusted to fit within a reduced carrier channel bandwidth.

Additionally, or alternatively, the UE 900 may be configured to support any one or combination of the channel de-interleaving corresponds to an inverse of a channel interleaving pattern applied at a transmitter of the SSB. This aspect enables the UE 900 to reverse the bit reordering performed at the transmitter, restoring the polar codeword to its original order for decoding.

Additionally, or alternatively, the UE 900 may be configured to support any one or combination of, to determine whether to enable the channel de-interleaving, the UE 900 detects the carrier channel bandwidth based on receiving the SSB, enables the channel de-interleaving if the carrier channel bandwidth is less than five MHz, and disables the channel de-interleaving if the carrier channel bandwidth is equal to or greater than five MHz. This aspect enables the UE 900 to conditionally apply channel de-interleaving based on the carrier channel bandwidth, maintaining compatibility with legacy transmissions that do not use channel interleaving.

Additionally, or alternatively, the UE 900 may be configured to support any one or combination of, to determine whether to enable the channel de-interleaving, the UE 900 detects the carrier channel bandwidth based on receiving the SSB, enables the channel de-interleaving if the carrier channel bandwidth is less than a bandwidth of the SSB, and disables the channel de-interleaving if the carrier channel bandwidth is equal to or greater than the bandwidth of the SSB. This aspect enables the UE 900 to conditionally apply channel de-interleaving based on a comparison between the carrier channel bandwidth and the SSB bandwidth, supporting flexible bandwidth configurations.

Additionally, or alternatively, the UE 900 may be configured to support any one or combination of the synchronization raster is a single synchronization raster used for a first bandwidth and a second bandwidth greater than the first bandwidth, and where the single synchronization raster has a raster spacing that is a common divisor of the first bandwidth and the second bandwidth. This aspect enables the UE 900 to operate on a unified synchronization raster that supports multiple carrier channel bandwidths, reducing complexity associated with scanning multiple synchronization rasters during initial access.

Additionally, or alternatively, the UE 900 may be configured to support any one or combination of, to determine whether to enable the channel de-interleaving, the UE 900 detects a PCI from at least one of a PSS or an SSS in the SSB, enables the channel de-interleaving if the PCI belongs to a first set of PCIs corresponding to the first bandwidth, and disables the channel de-interleaving if the PCI belongs to a second set of PCIs corresponding to the second bandwidth. This aspect enables the UE 900 to determine whether to apply channel de-interleaving based on the PCI, supporting implicit signaling of the carrier channel bandwidth through the SSB.

Additionally, or alternatively, the UE 900 may be configured to support any one or combination of, to determine whether to enable the channel de-interleaving, the UE 900 enables the channel de-interleaving if the synchronization raster is a first synchronization raster associated with a first bandwidth and disables the channel de-interleaving if the synchronization raster is a second synchronization raster associated with a second bandwidth greater than the first bandwidth. This aspect enables the UE 900 to determine whether to apply channel de-interleaving based on which synchronization raster the UE 900 is configured to scan, supporting backward compatibility with dual synchronization raster deployments.

Additionally, or alternatively, the UE 900 may support at least one memory (e.g., the memory 904) and at least one processor (e.g., the processor 902) coupled with the at least one memory and configured to cause the UE receive an SSB over a synchronization raster, apply channel de-interleaving to received bits of the SSB to generate de-interleaved bits as a result of a determination to enable the channel de-interleaving based on a carrier channel bandwidth, and decode, using a polar decoder, a PBCH payload based on the de-interleaved bits. In this manner, the UE 900 supports decoding of PBCH transmissions where channel interleaving was applied to protect reliable bit-channels from RB-level puncturing, which preserves decoder performance when the SSB is adjusted to fit within a reduced carrier channel bandwidth.

Additionally, or alternatively, the UE 900 may be configured to support any one or combination of the channel de-interleaving corresponds to an inverse of a channel interleaving pattern applied at a transmitter of the SSB. This aspect enables the UE 900 to reverse the bit reordering performed at the transmitter, restoring the polar codeword to its original order for decoding.

Additionally, or alternatively, the UE 900 may be configured to support any one or combination of, to determine whether to enable the channel de-interleaving, the at least one processor is operable to cause the UE 900 to detect the carrier channel bandwidth based on receiving the SSB, enable the channel de-interleaving if the carrier channel bandwidth is less than five MHz, and disable the channel de-interleaving if the carrier channel bandwidth is equal to or greater than five MHz. This aspect enables the UE 900 to conditionally apply channel de-interleaving based on the carrier channel bandwidth, maintaining compatibility with legacy transmissions that do not use channel interleaving.

Additionally, or alternatively, the UE 900 may be configured to support any one or combination of, to determine whether to enable the channel de-interleaving, the at least one processor is operable to cause the UE 900 to detect the carrier channel bandwidth based on receiving the SSB, enable the channel de-interleaving if the carrier channel bandwidth is less than a bandwidth of the SSB, and disable the channel de-interleaving if the carrier channel bandwidth is equal to or greater than the bandwidth of the SSB. This aspect enables the UE 900 to conditionally apply channel de-interleaving based on a comparison between the carrier channel bandwidth and the SSB bandwidth, supporting flexible bandwidth configurations.

Additionally, or alternatively, the UE 900 may be configured to support any one or combination of, to determine whether to enable the channel de-interleaving, the at least one processor is operable to cause the UE 900 to detect a PCI from at least one of a PSS or an SSS in the SSB, enable the channel de-interleaving if the PCI belongs to a first set of PCIs corresponding to the first bandwidth, and disable the channel de-interleaving if the PCI belongs to a second set of PCIs corresponding to the second bandwidth. This aspect enables the UE 900 to determine whether to apply channel de-interleaving based on the PCI, supporting implicit signaling of the carrier channel bandwidth through the SSB.

Additionally, or alternatively, the UE 900 may be configured to support any one or combination of, to determine whether to enable the channel de-interleaving, the at least one processor is operable to cause the UE 900 to enable the channel de-interleaving if the synchronization raster is a first synchronization raster associated with a first bandwidth and disable the channel de-interleaving if the synchronization raster is a second synchronization raster associated with a second bandwidth greater than the first bandwidth. This aspect enables the UE 900 to determine whether to apply channel de-interleaving based on which synchronization raster the UE 900 is configured to scan, supporting backward compatibility with dual synchronization raster deployments.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to encode, using a polar encoder, a PBCH payload according to a polar sequence to generate a polar codeword, where the PBCH payload is associated with an SSB, apply a channel interleaving pattern to the polar codeword as a result of a determination to enable channel interleaving based on a carrier channel bandwidth, adjust the SSB to fit within the carrier channel bandwidth, and transmit the SSB including the PBCH payload over a synchronization raster within the carrier channel bandwidth. In this manner, the processor 1000 supports improved PBCH decoding performance when the SSB is adjusted to fit within a reduced carrier channel bandwidth by ensuring that puncturing operations remove bits corresponding to unreliable bit-channels rather than bits corresponding to reliable bit-channels.

Additionally, or alternatively, the processor 1000 may be configured to or operable to support any one or combination of the channel interleaving pattern includes a pre-defined permutation configured to map polar bits corresponding to reliable bit-channels to REs that are preserved when adjusting the SSB to fit within the carrier channel bandwidth. This aspect ensures that information bits and parity bits transmitted over reliable bit-channels are protected from puncturing, preserving polar decoder performance at the receiver.

Additionally, or alternatively, the processor 1000 may be configured to or operable to support any one or combination of adjusting the SSB to fit within the carrier channel bandwidth includes puncturing one or more resource blocks from at least one of an upper frequency edge or a lower frequency edge of the SSB based on a bandwidth of the SSB being greater than the carrier channel bandwidth. This aspect enables the SSB to fit within narrower carrier channel bandwidths while the channel interleaving pattern ensures that punctured REs correspond to frozen bits rather than information bits or parity bits.

Additionally, or alternatively, the processor 1000 may be configured to or operable to support any one or combination of selecting the channel interleaving pattern from a set of channel interleaving patterns based on a quantity of resource blocks available for transmission of the SSB or the carrier channel bandwidth. This aspect provides flexibility to adapt the channel interleaving pattern to different deployment scenarios and carrier channel bandwidth configurations.

Additionally, or alternatively, the processor 1000 may be configured to or operable to support any one or combination of the channel interleaving pattern is configured based on the polar sequence, and the processor is operable to map bits corresponding to frozen bit positions in the polar sequence to REs in at least one of an upper frequency edge or a lower frequency edge of the SSB, and map bits corresponding to information bit positions and parity bit positions in the polar sequence to REs at a center frequency region of the SSB. This aspect ensures that when RB-level puncturing is performed, the punctured REs correspond to frozen bits transmitted over unreliable bit-channels, preserving the integrity of the polar code structure and maintaining decoder performance.

Additionally, or alternatively, the processor 1000 may be configured to or operable to support any one or combination of enabling the channel interleaving if the carrier channel bandwidth is less than five MHz, and disabling the channel interleaving if the carrier channel bandwidth is equal to or greater than five MHz. This aspect maintains compatibility with devices operating on wider channel bandwidths while providing improved performance for devices operating on narrower channel bandwidths.

Additionally, or alternatively, the processor 1000 may be configured to or operable to support any one or combination of enabling the channel interleaving if the carrier channel bandwidth is less than a bandwidth of the SSB, and disabling the channel interleaving if the carrier channel bandwidth is equal to or greater than the bandwidth of the SSB. This aspect enables dynamic adaptation of the encoding chain based on the relationship between the carrier channel bandwidth and the SSB bandwidth.

Additionally, or alternatively, the processor 1000 may be configured to or operable to support any one or combination of the synchronization raster is a single synchronization raster used for a first bandwidth and a second bandwidth greater than the first bandwidth, and the single synchronization raster has a raster spacing that is a common divisor of the first bandwidth and the second bandwidth. This aspect enables a unified synchronization raster design that supports multiple carrier channel bandwidths, reducing complexity for UE cell search procedures.

Additionally, or alternatively, the processor 1000 may be configured to or operable to support any one or combination of a first set of PCIs corresponds to the first bandwidth and a second set of PCIs corresponds to the second bandwidth, and the processor is operable to generate, using a PCI corresponding to the carrier channel bandwidth, a PSS and an SSS included in the SSB, where the PCI indicates the carrier channel bandwidth. This aspect enables implicit signaling of the carrier channel bandwidth to the UE through the PCI, allowing the UE to determine whether to enable channel de-interleaving without additional signaling overhead.

Additionally, or alternatively, the processor 1000 may be configured to or operable to support any one or combination of a first synchronization raster is associated with a first bandwidth, a second synchronization raster is associated with a second bandwidth greater than the first bandwidth, and the synchronization raster over which the SSB is transmitted is the first synchronization raster if the carrier channel bandwidth corresponds to the first bandwidth and is the second synchronization raster if the carrier channel bandwidth corresponds to the second bandwidth. This aspect enables the UE to determine the carrier channel bandwidth based on the synchronization raster, allowing the UE to select the appropriate de-interleaving configuration.

Additionally, or alternatively, the processor 1000 may be configured to or operable to support any one or combination of adjusting the SSB includes, if the carrier channel bandwidth corresponds to the first bandwidth, puncturing the polar codeword to obtain a rate-matched sequence having a first sequence length, and if the carrier channel bandwidth corresponds to the second bandwidth, repeating bits of the polar codeword to obtain the rate-matched sequence having a second sequence length, where the second sequence length is greater than the first sequence length. This aspect enables the processor 1000 to adapt the rate matching operation based on the carrier channel bandwidth, using puncturing for narrower bandwidths and repetition for wider bandwidths.

Additionally, or alternatively, the processor 1000 may be configured to or operable to support at least one controller (e.g., the controller 1002) coupled with at least one memory (e.g., the memory 1004) and configured to cause the processor to receive an SSB over a synchronization raster, apply channel de-interleaving to received bits of the SSB to generate de-interleaved bits as a result of a determination to enable the channel de-interleaving based on a carrier channel bandwidth, and decode, using a polar decoder, a PBCH payload based on the de-interleaved bits. In this manner, the processor 1000 supports improved PBCH decoding performance by reversing the channel interleaving applied at the transmitter, enabling the polar decoder to process bits in the correct order for reliable decoding.

Additionally, or alternatively, the processor 1000 may be configured to or operable to support any one or combination of the channel de-interleaving corresponds to an inverse of a channel interleaving pattern applied at a transmitter of the SSB. This aspect ensures that the de-interleaving operation correctly reverses the interleaving applied at the transmitter, restoring the original bit order for polar decoding.

Additionally, or alternatively, the processor 1000 may be configured to or operable to support any one or combination of determining whether to enable the channel de-interleaving includes detecting the carrier channel bandwidth based on receiving the SSB, enabling the channel de-interleaving if the carrier channel bandwidth is less than five MHz, and disabling the channel de-interleaving if the carrier channel bandwidth is equal to or greater than five MHz. This aspect enables the processor 1000 to automatically determine whether channel de-interleaving is required based on the detected carrier channel bandwidth, maintaining compatibility with both narrowband and wideband deployments.

Additionally, or alternatively, the processor 1000 may be configured to or operable to support any one or combination of determining whether to enable the channel de-interleaving includes detecting the carrier channel bandwidth based on receiving the SSB, enabling the channel de-interleaving if the carrier channel bandwidth is less than a bandwidth of the SSB, and disabling the channel de-interleaving if the carrier channel bandwidth is equal to or greater than the bandwidth of the SSB. This aspect enables dynamic adaptation of the decoding chain based on the relationship between the carrier channel bandwidth and the SSB bandwidth.

Additionally, or alternatively, the processor 1000 may be configured to or operable to support any one or combination of the synchronization raster is a single synchronization raster used for a first bandwidth and a second bandwidth greater than the first bandwidth, and the single synchronization raster has a raster spacing that is a common divisor of the first bandwidth and the second bandwidth. This aspect enables the processor 1000 to operate with a unified synchronization raster design that supports multiple carrier channel bandwidths, simplifying cell search procedures.

Additionally, or alternatively, the processor 1000 may be configured to or operable to support any one or combination of determining whether to enable the channel de-interleaving includes detecting a PCI from at least one of a PSS or an SSS in the SSB, enabling the channel de-interleaving if the PCI belongs to a first set of PCIs corresponding to the first bandwidth, and disabling the channel de-interleaving if the PCI belongs to a second set of PCIs corresponding to the second bandwidth. This aspect enables the processor 1000 to determine the carrier channel bandwidth and the appropriate de-interleaving configuration based on the detected PCI without additional signaling.

Additionally, or alternatively, the processor 1000 may be configured to or operable to support any one or combination of determining whether to enable the channel de-interleaving includes enabling the channel de-interleaving if the synchronization raster is a first synchronization raster associated with a first bandwidth, and disabling the channel de-interleaving if the synchronization raster is a second synchronization raster associated with a second bandwidth greater than the first bandwidth. This aspect enables the processor 1000 to determine the appropriate de-interleaving configuration based on the synchronization raster on which the SSB was received.

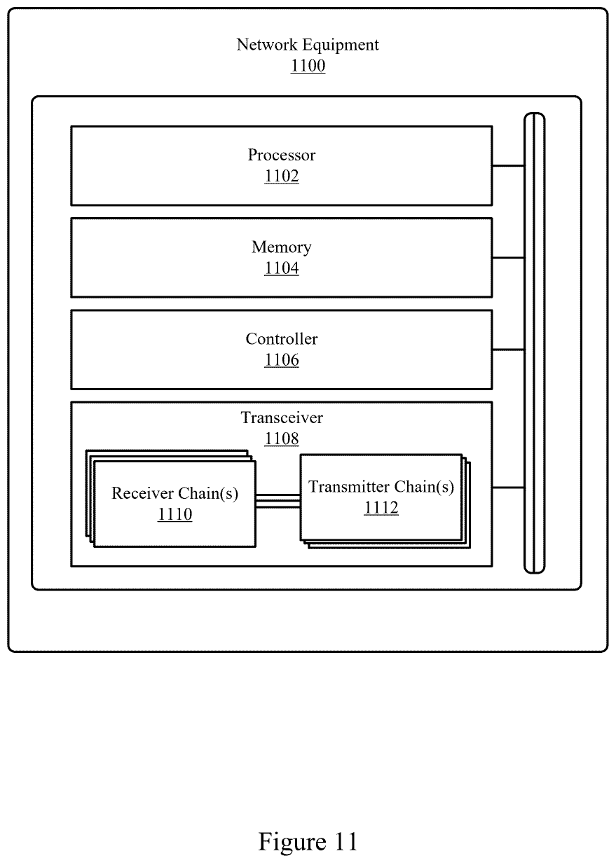

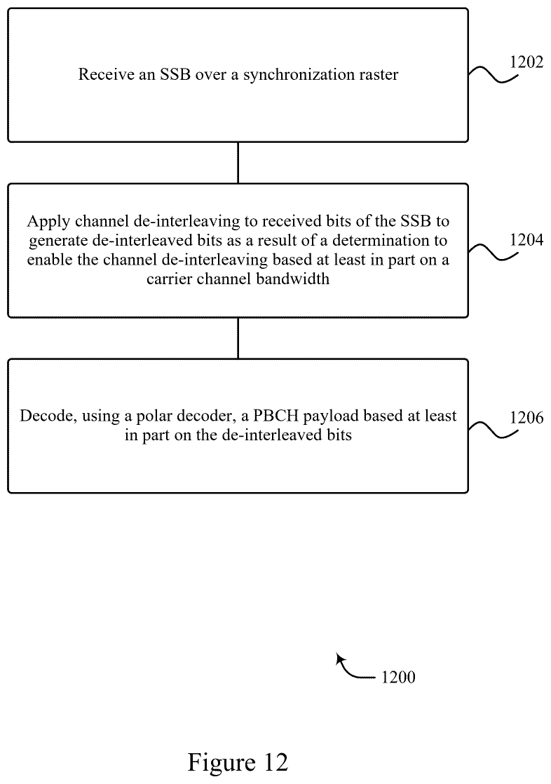

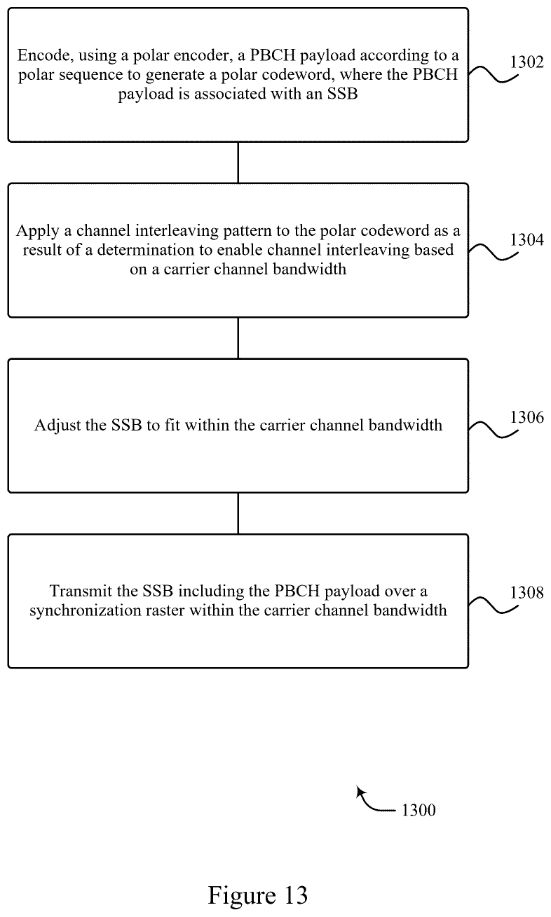

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to or operable to support a means for encoding, using a polar encoder, a PBCH payload according to a polar sequence to generate a polar codeword, where the PBCH payload is associated with an SSB, applying a channel interleaving pattern to the polar codeword as a result of a determination to enable channel interleaving based on a carrier channel bandwidth, adjusting the SSB to fit within the carrier channel bandwidth, and transmitting the SSB including the PBCH payload over a synchronization raster within the carrier channel bandwidth. In this manner, the NE 1100 supports improved PBCH decoding performance when the SSB is adjusted to fit within a reduced carrier channel bandwidth by ensuring that puncturing operations remove bits corresponding to unreliable bit-channels rather than bits corresponding to reliable bit-channels.

Additionally, or alternatively, the NE 1100 may be configured to support any one or combination of the channel interleaving pattern includes a pre-defined permutation configured to map polar bits corresponding to reliable bit-channels to REs that are preserved when adjusting the SSB to fit within the carrier channel bandwidth. This aspect ensures that information bits and parity bits transmitted over reliable bit-channels are protected from puncturing, preserving polar decoder performance at the receiver.

Additionally, or alternatively, the NE 1100 may be configured to support any one or combination of adjusting the SSB to fit within the carrier channel bandwidth includes puncturing one or more resource blocks from at least one of an upper frequency edge or a lower frequency edge of the SSB based on a bandwidth of the SSB being greater than the carrier channel bandwidth. This aspect enables the SSB to fit within narrower carrier channel bandwidths while the channel interleaving pattern ensures that punctured REs correspond to frozen bits rather than information bits or parity bits.

Additionally, or alternatively, the NE 1100 may be configured to support any one or combination of selecting the channel interleaving pattern from a set of channel interleaving patterns based on a quantity of resource blocks available for transmission of the SSB or the carrier channel bandwidth. This aspect provides flexibility to adapt the channel interleaving pattern to different deployment scenarios and carrier channel bandwidth configurations.

Additionally, or alternatively, the NE 1100 may be configured to support any one or combination of the channel interleaving pattern is configured based on the polar sequence, and applying the channel interleaving pattern includes mapping bits corresponding to frozen bit positions in the polar sequence to REs in at least one of an upper frequency edge or a lower frequency edge of the SSB, and mapping bits corresponding to information bit positions and parity bit positions in the polar sequence to REs at a center frequency region of the SSB. This aspect ensures that when RB-level puncturing is performed, the punctured REs correspond to frozen bits transmitted over unreliable bit-channels, preserving the integrity of the polar code structure and maintaining decoder performance.

Additionally, or alternatively, the NE 1100 may be configured to support any one or combination of enabling the channel interleaving if the carrier channel bandwidth is less than five MHz, and disabling the channel interleaving if the carrier channel bandwidth is equal to or greater than five MHz. This aspect maintains compatibility with devices operating on wider channel bandwidths while providing improved performance for devices operating on narrower channel bandwidths.

Additionally, or alternatively, the NE 1100 may be configured to support any one or combination of enabling the channel interleaving if the carrier channel bandwidth is less than a bandwidth of the SSB, and disabling the channel interleaving if the carrier channel bandwidth is equal to or greater than the bandwidth of the SSB. This aspect enables dynamic adaptation of the encoding chain based on the relationship between the carrier channel bandwidth and the SSB bandwidth.

Additionally, or alternatively, the NE 1100 may be configured to support any one or combination of the synchronization raster is a single synchronization raster used for a first bandwidth and a second bandwidth greater than the first bandwidth, and the single synchronization raster has a raster spacing that is a common divisor of the first bandwidth and the second bandwidth. This aspect enables a unified synchronization raster design that supports multiple carrier channel bandwidths, reducing complexity for UE cell search procedures.

Additionally, or alternatively, the NE 1100 may be configured to support any one or combination of a first set of PCIs corresponds to the first bandwidth and a second set of PCIs corresponds to the second bandwidth, and generating, using a PCI corresponding to the carrier channel bandwidth, a PSS and an SSS included in the SSB, where the PCI indicates the carrier channel bandwidth. This aspect enables implicit signaling of the carrier channel bandwidth to the UE through the PCI, allowing the UE to determine whether to enable channel de-interleaving without additional signaling overhead.

Additionally, or alternatively, the NE 1100 may be configured to support any one or combination of a first synchronization raster is associated with a first bandwidth, a second synchronization raster is associated with a second bandwidth greater than the first bandwidth, and the synchronization raster over which the SSB is transmitted is the first synchronization raster if the carrier channel bandwidth corresponds to the first bandwidth and is the second synchronization raster if the carrier channel bandwidth corresponds to the second bandwidth. This aspect enables the UE to determine the carrier channel bandwidth based on the synchronization raster, allowing the UE to select the appropriate de-interleaving configuration.

Additionally, or alternatively, the NE 1100 may be configured to support any one or combination of adjusting the SSB includes, if the carrier channel bandwidth corresponds to the first bandwidth, puncturing the polar codeword to obtain a rate-matched sequence having a first sequence length, and if the carrier channel bandwidth corresponds to the second bandwidth, repeating bits of the polar codeword to obtain the rate-matched sequence having a second sequence length, where the second sequence length is greater than the first sequence length. This aspect enables the NE 1100 to adapt the rate matching operation based on the carrier channel bandwidth, using puncturing for narrower bandwidths and repetition for wider bandwidths.

Additionally, or alternatively, the NE 1100 may support at least one memory (e.g., the memory 1104) and at least one processor (e.g., the processor 1102) coupled with the at least one memory and configured to cause the NE 1100 to encode, using a polar encoder, a PBCH payload according to a polar sequence to generate a polar codeword, where the PBCH payload is associated with an SSB, apply a channel interleaving pattern to the polar codeword as a result of a determination to enable channel interleaving based on a carrier channel bandwidth, adjust the SSB to fit within the carrier channel bandwidth, and transmit the SSB including the PBCH payload over a synchronization raster within the carrier channel bandwidth. In this manner, the NE 1100 supports improved PBCH decoding performance when the SSB is adjusted to fit within a reduced carrier channel bandwidth by ensuring that puncturing operations remove bits corresponding to unreliable bit-channels rather than bits corresponding to reliable bit-channels.

Additionally, or alternatively, the NE 1100 may be configured to support any one or combination of the channel interleaving pattern includes a pre-defined permutation configured to map polar bits corresponding to reliable bit-channels to REs that are preserved when adjusting the SSB to fit within the carrier channel bandwidth. This aspect ensures that information bits and parity bits transmitted over reliable bit-channels are protected from puncturing, preserving polar decoder performance at the receiver.

Additionally, or alternatively, the NE 1100 may be configured to support any one or combination of adjusting the SSB to fit within the carrier channel bandwidth includes puncturing one or more resource blocks from at least one of an upper frequency edge or a lower frequency edge of the SSB based on a bandwidth of the SSB being greater than the carrier channel bandwidth. This aspect enables the SSB to fit within narrower carrier channel bandwidths while the channel interleaving pattern ensures that punctured REs correspond to frozen bits rather than information bits or parity bits.

Additionally, or alternatively, the NE 1100 may be configured to support any one or combination of selecting the channel interleaving pattern from a set of channel interleaving patterns based on a quantity of resource blocks available for transmission of the SSB or the carrier channel bandwidth. This aspect provides flexibility to adapt the channel interleaving pattern to different deployment scenarios and carrier channel bandwidth configurations.

Additionally, or alternatively, the NE 1100 may be configured to support any one or combination of the channel interleaving pattern is configured based on the polar sequence, and the at least one processor is operable to cause the NE 1100 to map bits corresponding to frozen bit positions in the polar sequence to REs in at least one of an upper frequency edge or a lower frequency edge of the SSB, and map bits corresponding to information bit positions and parity bit positions in the polar sequence to REs at a center frequency region of the SSB. This aspect ensures that when RB-level puncturing is performed, the punctured REs correspond to frozen bits transmitted over unreliable bit-channels, preserving the integrity of the polar code structure and maintaining decoder performance.

Additionally, or alternatively, the NE 1100 may be configured to support any one or combination of the at least one processor is operable to cause the NE 1100 to enable the channel interleaving if the carrier channel bandwidth is less than five MHz, and disable the channel interleaving if the carrier channel bandwidth is equal to or greater than five MHz. This aspect maintains compatibility with devices operating on wider channel bandwidths while providing improved performance for devices operating on narrower channel bandwidths.

Additionally, or alternatively, the NE 1100 may be configured to support any one or combination of the at least one processor is operable to cause the NE 1100 to enable the channel interleaving if the carrier channel bandwidth is less than a bandwidth of the SSB, and disable the channel interleaving if the carrier channel bandwidth is equal to or greater than the bandwidth of the SSB. This aspect enables dynamic adaptation of the encoding chain based on the relationship between the carrier channel bandwidth and the SSB bandwidth.

Additionally, or alternatively, the NE 1100 may be configured to support any one or combination of the synchronization raster is a single synchronization raster used for a first bandwidth and a second bandwidth greater than the first bandwidth, and the single synchronization raster has a raster spacing that is a common divisor of the first bandwidth and the second bandwidth. This aspect enables a unified synchronization raster design that supports multiple carrier channel bandwidths, reducing complexity for UE cell search procedures.

Additionally, or alternatively, the NE 1100 may be configured to support any one or combination of a first set of PCIs corresponds to the first bandwidth and a second set of PCIs corresponds to the second bandwidth, and the at least one processor is operable to cause the NE 1100 to generate, using a PCI corresponding to the carrier channel bandwidth, a PSS and an SSS included in the SSB, where the PCI indicates the carrier channel bandwidth. This aspect enables implicit signaling of the carrier channel bandwidth to the UE through the PCI, allowing the UE to determine whether to enable channel de-interleaving without additional signaling overhead.

Additionally, or alternatively, the NE 1100 may be configured to support any one or combination of a first synchronization raster is associated with a first bandwidth, a second synchronization raster is associated with a second bandwidth greater than the first bandwidth, and the synchronization raster over which the SSB is transmitted is the first synchronization raster if the carrier channel bandwidth corresponds to the first bandwidth and is the second synchronization raster if the carrier channel bandwidth corresponds to the second bandwidth. This aspect enables the UE to determine the carrier channel bandwidth based on the synchronization raster, allowing the UE to select the appropriate de-interleaving configuration.

Additionally, or alternatively, the NE 1100 may be configured to support any one or combination of the at least one processor is operable to cause the NE 1100 to, if the carrier channel bandwidth corresponds to the first bandwidth, puncture the polar codeword to obtain a rate-matched sequence having a first sequence length, and if the carrier channel bandwidth corresponds to the second bandwidth, repeat bits of the polar codeword to obtain the rate-matched sequence having a second sequence length, where the second sequence length is greater than the first sequence length. This aspect enables the NE 1100 to adapt the rate matching operation based on the carrier channel bandwidth, using puncturing for narrower bandwidths and repetition for wider bandwidths.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., an LNA) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

FIG. 12 illustrates a flowchart of a method 1200 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1202, the method may include receiving an SSB over a synchronization raster. The operations of 1202 may be performed in accordance with examples as described herein. In some implementations, aspects of the operations of 1202 may be performed by a UE as described with reference to FIG. 9.

At 1204, the method may include applying channel de-interleaving to received bits of the SSB to generate de-interleaved bits as a result of a determination to enable the channel de-interleaving based on a carrier channel bandwidth. The operations of 1204 may be performed in accordance with examples as described herein. In some implementations, aspects of the operations of 1204 may be performed by a UE as described with reference to FIG. 9.

At 1206, the method may include decoding, using a polar decoder, a PBCH payload based on the de-interleaved bits. The operations of 1206 may be performed in accordance with examples as described herein. In some implementations, aspects of the operations of 1206 may be performed a UE as described with reference to FIG. 9.

FIG. 13 illustrates a flowchart of a method 1300 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include encoding, using a polar encoder, a PBCH payload according to a polar sequence to generate a polar codeword, where the PBCH payload is associated with an SSB. The operations of 1302 may be performed in accordance with examples as described herein. In some implementations, aspects of the operations of 1302 may be performed by an NE as described with reference to FIG. 11.

At 1304, the method may include applying a channel interleaving pattern to the polar codeword as a result of a determination to enable channel interleaving based on a carrier channel bandwidth. The operations of 1304 may be performed in accordance with examples as described herein. In some implementations, aspects of the operations of 1304 may be performed by an NE as described with reference to FIG. 11.

At 1306, the method may include adjusting the SSB to fit within the carrier channel bandwidth. The operations of 1306 may be performed in accordance with examples as described herein. In some implementations, aspects of the operations of 1306 may be performed an NE as described with reference to FIG. 11.

At 1308, the method may include transmitting the SSB including the PBCH payload over a synchronization raster within the carrier channel bandwidth. The operations of 1308 may be performed in accordance with examples as described herein. In some implementations, aspects of the operations of 1308 may be performed an NE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity (NE) for wireless communication, comprising:
at least one memory; and
at least one processor coupled with the at least one memory and operable to cause the NE to:
encode, using a polar encoder, a physical broadcast channel (PBCH) payload according to a polar sequence to generate a polar codeword, wherein the PBCH payload is associated with a synchronization signal block (SSB);
apply a channel interleaving pattern to the polar codeword as a result of a determination to enable channel interleaving based at least in part on a carrier channel bandwidth;
adjust the SSB to fit within the carrier channel bandwidth; and
transmit the SSB including the PBCH payload over a synchronization raster within the carrier channel bandwidth.

2. The NE of claim 1, wherein the channel interleaving pattern comprises a pre-defined permutation configured to map polar bits corresponding to reliable bit-channels to REs that are preserved when adjusting the SSB to fit within the carrier channel bandwidth.

3. The NE of claim 2, wherein, to adjust the SSB to fit within the carrier channel bandwidth, the at least one processor is further operable to cause the NE to puncture one or more resource blocks from at least one of an upper frequency edge or a lower frequency edge of the SSB based at least in part on a bandwidth of the SSB being greater than the carrier channel bandwidth.

4. The NE of claim 1, wherein the at least one processor is further operable to select the channel interleaving pattern from a set of channel interleaving patterns based at least in part on a quantity of resource blocks available for transmission of the SSB or the carrier channel bandwidth.

5. The NE of claim 1, wherein the channel interleaving pattern is configured based at least in part on the polar sequence, and wherein the at least one processor is further operable to cause the NE to:
map bits corresponding to frozen bit positions in the polar sequence to REs in at least one of an upper frequency edge or a lower frequency edge of the SSB; and
map bits corresponding to information bit positions and parity bit positions in the polar sequence to REs at a center frequency region of the SSB.

6. The NE of claim 1, wherein the at least one processor is further operable to cause the NE to:
enable the channel interleaving if the carrier channel bandwidth is less than five megahertz (MHz); and
disable the channel interleaving if the carrier channel bandwidth is equal to or greater than five MHz.

7. The NE of claim 1, wherein the at least one processor is further operable to cause the NE to:
enable the channel interleaving if the carrier channel bandwidth is less than a bandwidth of the SSB; and
disable the channel interleaving if the carrier channel bandwidth is equal to or greater than the bandwidth of the SSB.

8. The NE of claim 1, wherein the synchronization raster is a single synchronization raster used for a first bandwidth and a second bandwidth greater than the first bandwidth, and wherein the single synchronization raster has a raster spacing that is a common divisor of the first bandwidth and the second bandwidth.

9. The NE of claim 8, wherein:
a first set of physical cell identifiers (PCIs) corresponds to the first bandwidth and a second set of PCIs corresponds to the second bandwidth; and
the at least one processor is further operable to cause the NE to generate, using a PCI corresponding to the carrier channel bandwidth, a primary synchronization signal (PSS) and a secondary synchronization signal (SSS) included in the SSB, wherein the PCI indicates the carrier channel bandwidth.

10. The NE of claim 1, wherein:
a first synchronization raster is associated with a first bandwidth;
a second synchronization raster is associated with a second bandwidth greater than the first bandwidth; and
the synchronization raster over which the SSB is transmitted is the first synchronization raster if the carrier channel bandwidth corresponds to the first bandwidth and is the second synchronization raster if the carrier channel bandwidth corresponds to the second bandwidth.

11. The NE of claim 10, wherein, to adjust the SSB, the at least one processor is further operable to cause the NE to:
if the carrier channel bandwidth corresponds to the first bandwidth, puncture the polar codeword to obtain a rate-matched sequence having a first sequence length; and
if the carrier channel bandwidth corresponds to the second bandwidth, repeat bits of the polar codeword to obtain the rate-matched sequence having a second sequence length, wherein the second sequence length is greater than the first sequence length.

12. A user equipment (UE) for wireless communication, comprising:
at least one memory; and
at least one processor coupled with the at least one memory and operable to cause the UE to:
receive a synchronization signal block (SSB) over a synchronization raster;
apply channel de-interleaving to received bits of the SSB to generate de-interleaved bits as a result of a determination to enable the channel de-interleaving based at least in part on a carrier channel bandwidth; and
decode, using a polar decoder, a physical broadcast channel (PBCH) payload based at least in part on the de-interleaved bits.

13. The UE of claim 12, wherein the channel de-interleaving corresponds to an inverse of a channel interleaving pattern applied at a transmitter of the SSB.

14. The UE of claim 12, wherein, to determine whether to enable the channel de-interleaving, the at least one processor is further operable to cause the UE to:
detect the carrier channel bandwidth based at least in part on receiving the SSB;
enable the channel de-interleaving if the carrier channel bandwidth is less than five megahertz (MHz); and
disable the channel de-interleaving if the carrier channel bandwidth is equal to or greater than five MHz.

15. The UE of claim 12, wherein, to determine whether to enable the channel de-interleaving, the at least one processor is further operable to cause the UE to:
detect the carrier channel bandwidth based at least in part on receiving the SSB;
enable the channel de-interleaving if the carrier channel bandwidth is less than a bandwidth of the SSB; and
disable the channel de-interleaving if the carrier channel bandwidth is equal to or greater than the bandwidth of the SSB.

16. The UE of claim 12, wherein the synchronization raster is a single synchronization raster used for a first bandwidth and a second bandwidth greater than the first bandwidth, and wherein the single synchronization raster has a raster spacing that is a common divisor of the first bandwidth and the second bandwidth.

17. The UE of claim 16, wherein, to determine whether to enable the channel de-interleaving, the at least one processor is further operable to cause the UE to:
detect a physical cell identifier (PCI) from at least one of a primary synchronization signal (PSS) or a secondary synchronization signal (SSS) in the SSB;
enable the channel de-interleaving if the PCI belongs to a first set of PCIs corresponding to the first bandwidth; and
disable the channel de-interleaving if the PCI belongs to a second set of PCIs corresponding to the second bandwidth.

18. The UE of claim 12, wherein, to determine whether to enable the channel de-interleaving, the at least one processor is further operable to cause the UE to:
enable the channel de-interleaving if the synchronization raster is a first synchronization raster associated with a first bandwidth; and
disable the channel de-interleaving if the synchronization raster is a second synchronization raster associated with a second bandwidth greater than the first bandwidth.

19. A method performed by a network entity (NE), the method comprising:
encoding, using a polar encoder, a physical broadcast channel (PBCH) payload according to a polar sequence to generate a polar codeword, wherein the PBCH payload is associated with a synchronization signal block (SSB);
applying a channel interleaving pattern to the polar codeword as a result of a determination to enable channel interleaving based at least in part on a carrier channel bandwidth;
adjusting the SSB to fit within the carrier channel bandwidth; and
transmit the SSB including the PBCH payload over a synchronization raster within the carrier channel bandwidth.

20. A method performed by a user equipment (UE), the method comprising:
receiving a synchronization signal block (SSB) over a synchronization raster;
applying channel de-interleaving to received bits of the SSB to generate de-interleaved bits as a result of a determination to enable the channel de-interleaving based at least in part on a carrier channel bandwidth; and
decoding, using a polar decoder, a physical broadcast channel (PBCH) payload based at least in part on the de-interleaved bits.
